(19) United States
(12) Patent Application Publication
(10) Pub. No.: US 2025/0232533 A1
(43) Pub. Date: Jul. 17, 2025

(54) AUGMENTED REALITY SYSTEM FOR NETWORK MANAGEMENT

(71) Applicant: Cisco Technology, Inc., San Jose, CA (US)

(72) Inventors: Ashok K. Moghe, Pleasanton, CA (US); Hari Pillai, San Jose, CA (US); Avinash Kalyanaraman, San Francisco, CA (US)

(21) Appl. No.: 18/627,282

(22) Filed: Apr. 4, 2024

Related U.S. Application Data
(63) Continuation-in-part of application No. 18/414,318, filed on Jan. 16, 2024.

(51) Int. Cl. G06T 19/00; G06T 5/50

(52) U.S. Cl. CPC G06T 19/006; G06T 5/50; G06T 2207/20221

(57) ABSTRACT

Devices, networks, systems, methods, and processes for an Augmented Reality (AR) based device management. An AR device may receive an image depicting one or more objects, from a camera. The AR device may determine position data, including a position and an orientation, of the AR device, and transmit the position data and the image to an application server. The application server may identify the one or more objects in the image and obtain status data associated with the one or more objects. The application server may generate overlay data based on the status data of the objects. The application server may transmit the overlay data to the AR device. An augmented image generated based on the overlay data may be displayed on the AR device to present the object status data. Such augmented images integrate information with real-world objects, providing instant access to object status data and enhancing user understanding.

### CROSS-REFERENCE TO RELATED APPLICATION

This application is a Continuation in Part of U.S. Non-Provisional patent application Ser. No. 18/414,318, filed Jan. 16, 2024, which is incorporated by reference herein in its entirety.

The present disclosure relates to Augmented Reality (AR) systems. More particularly, the present disclosure relates to AR devices for management of digital infrastructure.

### BACKGROUND

In digital infrastructure, systems such as communication networks, data centers, power delivery networks, and electrical networks utilize a large number of interconnected devices. In these systems, connections between the devices are usually complex and dense. Such systems often provide a centralized controller that assists an operator with a logical view of the devices and the connections between the devices. However, while such centralized controllers can help in visualizing the devices and functional parameters of the devices, actual process of locating the devices and the connections is not very easy. For instance, in a server room, a large number of switches or routers are hosted in many stacks located side by side. In these stacks of switches, every switch may be connected to a different server or can belong to a different owner. Since all switches may look visually similar, differentiating between the switches can be very tricky and time consuming. In this case, for obtaining the functional parameters such as power consumption or operational states of the switches, the operator has to manually inspect the switches, distinguish between the switches, and then lookup the functional parameters in the centralized controller.

Additionally, the switches or routers may include visual status indicators such as light emitting diodes (LEDs) to indicate operational status of the switches or routers. For example, the LEDs may provide indications regarding link establishment, selected speed, ongoing data transfer, fault in the link, or similar operational statuses. Typically, these LEDs remain constantly active and therefore, consume a lot of power irrespective of whether someone is looking at these LEDs or not. This causes unnecessary energy wastage due to LED illuminated status indication. Further, LEDs are also part of network equipment, such as access points, projectors, or the like that are sometimes mounted on ceilings or places high up, and thus, the status depicted by these LEDs is not easily observable.

Conventional Augmented Reality (AR) devices, such as head mounted smart glasses or consoles, overlay information on images obtained by the AR devices through cameras. However, such information is passive information that is stored into the AR devices or in a user device that is connected to the AR devices. In context of managing the digital infrastructure, the conventional AR devices lack the ability to identify and provide relevant information related to the digital infrastructure. Furthermore, the conventional AR devices are often confined to specific applications, such as, for instance, immersive gaming, and can only provide predetermined information related specifically to these applications. While the images displayed by the AR devices are graphically appealing, they merely serve as a supplementary layer for passive data augmentation. Therefore, the conventional AR devices fail to provide solutions to management problems faced by most systems in the digital infrastructure.

### SUMMARY OF THE DISCLOSURE

Systems and methods for AR devices for management of digital infrastructure in accordance with embodiments of the disclosure are described herein.

In some embodiments, an augmented reality logic may be configured to receive an image, determine device position data, identify one or more objects visible in the image based on the device position data, obtain control data corresponding to the one or more objects, and generate an augmented image by superimposing the control data on the image.

In some embodiments, the augmented reality logic is further configured to access an object identification database, transmit an identification request indicative of the device position data to the object identification database, receive identification data from the object identification database in response to the identification request, and identify the one or more objects visible in the image based on the identification data.

In some embodiments, the augmented reality logic is further configured to receive biometric data, authenticate a user of the device based on the biometric data, and determine a user identifier corresponding to the user.

In some embodiments, the augmented reality logic is further configured to access an administrative database, transmit an access control request indicative of the user identifier to the administrative database, and receive access control data from the administrative database in response to the access control request.

In some embodiments, the augmented reality logic is further configured to identify one or more controllers associated with the one or more objects, transmit one or more status requests to the one or more controllers, and receive the control data from the one or more controllers in response to the one or more status requests.

In some embodiments, the one or more status requests are indicative of the identification data corresponding to the one or more objects, and the access control data corresponding to the user.

In some embodiments, the identification data is indicative of one or more of three-dimensional positional coordinates corresponding to the one or more objects, object identifiers corresponding to the one or more objects, or controllers associated with the one or more objects.

In some embodiments, the augmented reality logic is further configured to generate one or more control signals corresponding to the one or more objects based on the control data.

In some embodiments, the augmented reality logic is further configured to receive an input from the user and generate the one or more control signals based on the control data and the input.

In some embodiments, the augmented reality logic is further configured to transmit the one or more control signals to the one or more objects.

In some embodiments, the device position data includes three-dimensional positional coordinates indicative of a position of the device, and three-dimensional angular coordinates indicative of an orientation of the device.

In some embodiments, the augmented reality logic is further configured to receive the three-dimensional angular coordinates from an Inertial Measurement Unit (IMU).

In some embodiments, the augmented reality logic is further configured to determine the three-dimensional positional coordinates based on one or more Radio Frequency (RF) signals received by the device.

In some embodiments, the augmented reality logic is further configured to display the augmented image on a display.

In some embodiments, the one or more objects are one or more electronic devices.

In some embodiments, an augmented reality logic may be configured to receive an image, determine device position data indicative of position and orientation of the device, identify one or more electronic devices visible in the image based on the device position data, obtain control data corresponding to the one or more electronic devices, and generate one or more control signals corresponding to the one or more electronic devices based on the control data.

In some embodiments, the augmented reality logic is further configured to transmit the one or more control signals to the one or more electronic devices.

In some embodiments, the augmented reality logic is further configured to superimpose the control data on the image to generate an augmented image and display the augmented image.

In some embodiments, an image may be received, and a device position data indicative of position and orientation of a device is determined, one or more objects visible in the image based on the device position data may be identified, control data corresponding to the one or more objects may be obtained, an augmented image by superimposing the control data on the image may be generated, and the augmented image may be displayed.

In some embodiments, one or more controllers associated with the one or more objects may be identified, one or more status requests to the one or more controllers may be transmitted, and the control data from the one or more controllers in response to the one or more status requests may be received.

In some embodiments, a device includes a processor, a network interface controller configured to provide access to a network, and a memory communicatively coupled to the processor, wherein the memory includes an augmented reality management logic that is configured to receive an image and position data, identify one or more objects visible in the image based on the position data, obtain status data corresponding to the one or more objects, and generate, based on the status data, overlay data associated with the image.

In some embodiments, the augmented reality management logic is further configured to transmit the overlay data to an augmented reality display.

In some embodiments, the overlay data corresponds to an augmented overlay configured to be superimposed on the image.

In some embodiments, the overlay data is configured to facilitate a generation of an augmented overlay to be superimposed on the image.

In some embodiments, identifying the one or more objects visible in the image includes accessing an object identification database, transmitting an identification request to indicate the device position data to the object identification database, and receiving identification data from the object identification database in response to the identification request, wherein the one or more objects are identified based on the identification data.

In some embodiments, the augmented reality management logic is further configured to receive periodic status data of a plurality of objects, and store the periodic status data of the plurality of objects.

In some embodiments, obtaining the status data includes retrieving, from the stored periodic status data, the status data corresponding to the one or more objects.

In some embodiments, obtaining the status data includes identifying at least one controller associated with the one or more objects, transmitting a status request to the at least one controller, and receiving the status data corresponding to the one or more objects from the at least one controller in response to the status request.

In some embodiments, the status data includes power consumption data or version data of at least one of the one or more objects.

In some embodiments, the status data includes communication port statistics data or client statistics data of at least one of the one or more objects.

In some embodiments, the status data includes operational status data of at least one of the one or more objects.

In some embodiments, the operational status data includes at least one of a link status, a speed status, a fault status, or a data transfer status of at least one of the one or more objects.

In some embodiments, the augmented reality management logic is further configured to generate at least one control signal corresponding to the one or more objects based on the status data, and transmit the at least one control signal to the one or more objects.

In some embodiments, an augmented reality management logic is configured to receive an image and position data, identify one or more objects visible in the image based on the position data, obtain status data corresponding to the one or more objects, translate the status data into one or more visual indicators, and generate, based on the one or more visual indicators, overlay data associated with the image.

In some embodiments, the overlay data corresponds to an augmented overlay configured to be superimposed on the image.

In some embodiments, the augmented overlay includes the one or more visual indicators.

In some embodiments, at least one visual indicator of the one or more visual indicators is a graphical element.

In some embodiments, the graphical element is configured to be at least partially superimposed on at least one of the one or more objects visible in the image.

In some embodiments, the augmented reality management logic is further configured to access a mapping database and identify the one or more visual indicators corresponding to the status data in the mapping database, wherein the status data is translated in response to identification of the one or more visual indicators in the mapping database.

In some embodiments, a method includes receiving image and position data, identifying one or more objects visible in the image based on the position data, obtaining status data corresponding to the one or more objects, and generating, based on the status data, overlay data associated with the image.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a network, in accordance with various embodiments of the disclosure;

FIG. 2 is a conceptual illustration of an Augmented Reality (AR) device, in accordance with various embodiments of the disclosure;

FIG. 3 is a conceptual illustration of an AR view in an AR device, in accordance with various embodiments of the disclosure;

FIG. 4 is a conceptual illustration of position and orientation of an AR device, in accordance with various embodiments of the disclosure;

FIG. 5 is a conceptual network diagram of various environments that an AR device manager may operate on a plurality of network devices, in accordance with various embodiments of the disclosure;

FIG. 6 is a flowchart depicting a process for displaying an augmented image, in accordance with various embodiments of the disclosure;

FIG. 7 is a flowchart depicting a process for generating control signals, in accordance with various embodiments of the disclosure;

FIG. 8 is a flowchart depicting a process for controlling electronic devices, in accordance with various embodiments of the disclosure; and

FIG. 9 is a conceptual block diagram of a device suitable for configuration with an augmented reality logic, in accordance with various embodiments of the disclosure.

FIG. 10 is a conceptual illustration of a network in accordance with various embodiments of the disclosure.

FIG. 11 is a conceptual illustration of an AR process implemented via an application server and an AR device, in accordance with various embodiments of the disclosure.

FIG. 12 is a conceptual illustration of an AR view in an AR device, in accordance with various embodiments of the disclosure.

FIG. 13 is a conceptual illustration of an AR device displaying status data, in accordance with various embodiments of the disclosure.

FIG. 14 is a conceptual illustration of an AR device displaying visual indicators, in accordance with various embodiments of the disclosure.

FIG. 15 is a flowchart depicting a process for displaying status data on an AR device, in accordance with various embodiments of the disclosure.

FIG. 16 is a flowchart depicting a process for translation of status data into visual indicators, in accordance with various embodiments of the disclosure.

FIG. 17 a flowchart depicting a process for generating a control signal based on status data, in accordance with various embodiments of the disclosure.

FIG. 18 is a flowchart depicting a process for receiving periodic status of the one or more objects, in accordance with various embodiments of the disclosure.

FIG. 19 is a flowchart depicting a process for generating an augmented image, in accordance with various embodiments of the disclosure.

FIG. 20 is a flowchart depicting a process for an AR device generating an augmented image, in accordance with various embodiments of the disclosure.

FIG. 21 is a flowchart depicting a process for an AR device generating an augmented image, in accordance with various embodiments of the disclosure.

FIG. 22 is a conceptual block diagram of a device suitable for configuration with an augmented reality management logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods discussed herein provide an Augmented Reality (AR) device and an AR method to manage objects or electronic devices. In many embodiments, a device may implement an AR process. In some embodiments, the device can be an AR device. Examples of the AR device include, but are not limited to, smart glasses, AR glasses, AR headsets, AR goggles, or head mounted displays, etc. In certain embodiments, examples of the device include, but are not limited to, a smartphone, a tablet, or a personal computer, etc. The device can receive an image. In more embodiments, the device may be equipped with a camera to capture the image or to capture videos, in real-time or near-real time. In some more embodiments, the device may receive the image from an external source or an external device. In numerous embodiments, the device can retrieve the image from an internal memory or fetch the image from an external database. In many further embodiments, the image can be a frame in a video feed. The image may depict one or more objects. Examples of the objects may include network devices, such as but not limited to, switches, routers, or gateways, etc. More examples of the objects can also include connections between the devices, such as but not limited to, wires, cables, or optical fibers, etc. Further examples of the objects may include equipment or appliances, such as but not limited to, light bulbs, displays (for example, televisions or monitors), ceiling mounted devices such as projectors or smoke detectors, air conditioning systems, HVACs, or Wi-Fi Access Points (APs), etc. In still more embodiments, the objects can be Radio Frequency Identification (RFID) tags, Near-Field Communication (NFC) tags, QR codes, Bluetooth Low Energy (BLE) beacons, or barcodes etc. Some more examples of the objects include, but are not limited to, power supplies, wall plugs/outlets, generators, or batteries etc.

In a number of embodiments, the device can determine device position data. The device position data may include spatial data, including a position of the device and an orientation of the device. For the position of the device, the device position data may include three-dimensional coordinates, viz. x, y, z coordinates of the device. In some embodiments, for example, the x, y, z coordinates can indicate the position of the device in an indoor space, such as a room. In still more embodiments, the x, y, z coordinates can indicate the position of the device in an outdoor space. For the orientation of the device, the device position data may include three-dimensional angular coordinates, viz. θₓ, θ_{y}, θ_{z} angular coordinates of the device. In certain embodiments, for example, the θₓ, θ_{y}, θ_{z} angular coordinates can indicate the orientation, i.e., angles made by the device along x, y, z axes. In more embodiments, the device may determine the device position data by utilizing Wi-Fi positioning techniques such as trilateration/multilateration, Received Signal Strength Indication (RSSI) of Radio Frequency (RF) signals, Ultra-Wideband (UWB) positioning, fingerprinting, Angle of Arrival (AoA) or Time of Flight (ToF) etc. In some more embodiments, the device can determine the device position data based on data received from Inertial Measurement Unit (IMU), for example. For wearable devices, the orientation of the device may be indicative of a direction of a gaze of a user wearing the device. In that case, the image may be indicative of a Field of View (FOV) visible to the user.

In various embodiments, the device may detect the objects present in the image. In that, the device can detect one or more pixels in the image corresponding to the objects by implementing one or more image processing, object recognition, or computer vision techniques, for example. The device may determine spatial coordinates associated with the one or more pixels based on the device position data and image characteristics of the image. Examples of the image characteristics may include focal length, resolution, etc. of the image. The device can determine object position data based on the spatial coordinates associated with the one or more pixels corresponding to the objects. In some embodiments, for example, the object position data may indicate three-dimensional coordinates associated with the objects. Thereafter, the device may identify the detected objects. In certain embodiments, the device can identify the objects by accessing an object dentification database. The object identification database may include a mapping of the objects and their locations. The device can transmit an identification request to the object identification database. The identification request may include at least one of: the device position data or the object position data. The object identification database can retrieve object identifiers of the objects present in an area of space associated with the device position data and/or the object position data. The object identification database may transmit identification data to the device. The identification data may include information, such as but not limited to object identifiers, types of objects, or controllers associated with the objects, etc. The device can identify the objects based on the identification data. In numerous embodiments, the device may also identify the objects by scanning or processing QR codes, BLE beacons, barcodes, RFID tags, or NFC tags associated with the objects.

In additional embodiments, the device can determine one or more controllers associated with the objects (or electronic devices) based on the identification data. In some embodiments, for instance, when the object is a switch or a database, the device can determine a server or cloud server that is connected to the switch or the database. In certain embodiments, the device may be connected to the controllers by way of wired or wireless networks. In more embodiments, the device can communicate with the controllers through internet. The device can transmit a status request to a controller associated with an electronic device. In some more embodiments, for example, the status request may include an identifier (for example, Internet Protocol (IP) address or Media Access Control (MAC) address) associated with the electronic device, name of the electronic device, type of the electronic device, or other information indicated by the identification data corresponding to the electronic device. The controller may transmit control data to the device in response to the status request. The control data can be indicative of one or more parameters associated with the electronic device, such as but not limited to, power consumption, status (for example, whether the electronic device is ON/OFF or in a power saving mode, whether the device is online/offline, etc.), or other such parameters relevant to the electronic device. In examples where the object is a connector or a cable, the control data may indicate whether the connection is proper or functional, a speed of the connection, quality of the connection, etc. The device may superimpose the control data on the image to generate an augmented image. In some embodiments, for example, the device may utilize image processing or computer vision techniques to display the control data adjacent to a location of the electronic device in the image. The device can display the augmented image to the user.

In further embodiments, the device may receive biometric data corresponding to the user. In some embodiments, the device may be equipped with one or more biometric sensors, such as but not limited to a face recognition sensor, an iris recognition sensor, or a fingerprint sensor, etc. The biometric data may be generated by one or more biometric sensors when the user wears, handles, or interacts with the device. The device can authenticate the user based on the biometric data. The device may determine a user identifier (for example, name, username, or ID number) corresponding to the user. The device can further access an administrative database to determine a level of access authorized to the user. The administrative database may include user identifiers and corresponding authorizations, for example, access levels, etc. The device can transmit an access control request to the administrative database. The access control request may be indicative of the user identifier. The administrative database can transmit access control data in response to the access control request. In certain embodiments, for example, the access control data may be indicative of a portion of control data that is authorized to be accessed by the user. Thereafter, the device can select the portion of the control data that can be accessed by the user and superimpose the selected control data on the image to generate the augmented image. Thus, by restricting access to the control data, the device can ensure secure and selective access to different users of the device. In more embodiments, the device can utilize Artificial Intelligence (AI) or Machine Learning (ML) techniques to detect or identify the objects or electronic devices, to identify relevant control data, or to generate the augmented image.

In many more embodiments, the device can generate one or more control signals corresponding to the electronic device. In some embodiments, the device may receive an input from the user. In certain embodiments, for example, the device may receive a voice command, a gesture, or a touch, etc. from the user as the input. The device can generate the control signals based on the input received from the user. In more embodiments, the access control data may be indicative of whether the user is authorized to control the electronic device. In that case, the device can generate the control signals based on the input and the access control data. The device may transmit the control signal to the electronic device. In some more embodiments, the device can transmit the control signal to the controllers, or to any other devices associated with the electronic device, to relay the control signal to the electronic device. In numerous embodiments, the control signals may be indicative of changing the operational states (such as power saving modes, for example) of the electronic devices, switching the electronic devices ON/OFF, etc. In many further embodiments, the control signals can be indicative of changing power policies of the electronic devices.

Advantageously, the device of the present disclosure can facilitate easy control over physical objects such as the electronic devices. The device can select and display relevant control data in real-time or near-real time. The device may also facilitate access control for the control data, thereby providing secure access to different users. In power delivery infrastructure, the device can be utilized in to detect power losses. In data centers and communication networks, the device may be utilized to identify the switches that consume more power. Thus, the device can case or simplify management of systems that include a large number of interconnected devices.

In still more embodiments, the device may provide status information regarding one or more objects. In further embodiments, the status information may include information such as ownership data. Ownership data of network equipment may refer to legal or administrative ownership of the various devices that make up the digital infrastructure. Ownership data may include details such as the department or division responsible for managing network equipment, name of the business or organization that owns the network equipment, or other such details. In still additional embodiments, the status information may comprise hardware, software, or firmware version information. Version information may refer to unique version numbers or identifiers assigned to different releases or revisions of these components. Version information may help in tracking changes, updates, or improvements made to the hardware, software, or firmware over time, thus facilitating management, troubleshooting, and compatibility testing. In more embodiments, the status information may comprise box status data that refers to information related to the overall operational status and health of the network equipment itself. Box status data may include information such as device availability, interface status, motherboard information, model number, model revision, and such similar information.

In some more embodiments, the status information can include port statistics data or utilization data. Port statistics data can include various metrics such as number of incoming and outgoing packets, speed, status, duplex mode of the connection, number of packets discarded due to congestion, buffer overflows, or other reasons, error rates, number of broadcast and multicast packets received and transmitted on the port, and such network related information. Port statistics data can help network operators gain insights regarding traffic patterns, congestion issues, and overall performance of network ports. Port utilization is another important metric and may indicate the percentage of time a port is actively transmitting or receiving data relative to its maximum capacity. In a similar manner, utilization data for a switch or a piece of networking equipment may indicate information about the usage and performance of the resources of the switch (such as ports, memory, etc.) over a specific period of time.

In certain embodiments, the status information can include power information, thermal setting, or fan setting information. Power information may refer to details regarding input voltage, power consumption, power supply units (PSUs), and power over Ethernet (PoE) capabilities. Power information can also include information regarding power management features such as power saving modes, port scheduling, and usage of intelligent power management algorithms. Thermal setting information may refer to features related to managing and monitoring the temperature of the switch hardware to prevent overheating and component damage in the network equipment. Thermal settings may also include temperature compensation features to adjust the performance or power consumption based on temperature variations, or thermal management policies designed to optimize temperature control and energy efficiency based on specific deployment scenarios, workload characteristics, or environmental conditions. Network equipment may sometimes also include internal fans to dissipate heat generated by the hardware components. Thus, the status information may also include fan settings information having control options to adjust fan speed based on temperature conditions.

In yet more embodiments, the status information may include uptime information indicating the amount of time a network equipment has been continuously operational without experiencing downtime or interruptions. In still yet more embodiments, the status information may include configuration information for a piece of network equipment such as an access point. The configuration information may include information such as AP mode, location of the AP, VLAN interface status, antenna information, and other settings that dictate its operation within a network. In many further embodiments, the status information may comprise client statistics data for a piece of network equipment. For example, client statistics data for an AP may provide information regarding, but not limited to, the number of clients associated with the AP, closest client distance, type of clients (fixed or mobile), RSSI of the associated clients. In many additional embodiments, the status information may include Bluetooth connectivity data indicating scan timer status, scan interval, number of connected devices, power-saving mode, and other information.

In still yet further embodiments, the device may determine LED status data of one or more objects. For example, the LED status data may refer to visual indication of selected speed, status of link establishment, fault status, or ongoing data transfers provided via LEDs. In still yet additional embodiments, the status data may be presented by superimposing an augmented overlay of the status data on an image captured by the AR display. The status data may indicate statues of LEDs of at least one of the one or more objects. For example, networking platforms such as routers, switches, or the like have several status indicators in the form of different LEDs. These LEDs may be used to indicate various operational status of the networking platform such as an ongoing data transfer, link established, or the like. The device can thus identify one or more networking platforms visible through its FOV and can superimpose the LED status data on the image as visible in the FOV. Thus, the objects may not actually need physical LEDs for indicating statuses, instead the superimposed LED status data may provide the same look and feel to an onlooker. Additionally, the objects that already have LEDs may not need to spend energy on keeping the LEDs in ON state. Instead, the LEDs can remain turned OFF and the superimposed LED status data can provide the same look and feel of turned on LEDs to an onlooker.

In several embodiments, the device of the present disclosure can facilitate energy optimization for data centers comprising of multitude of switches, routers, and other networking equipment. Advantageously, the device of the present disclosure can present the LED status of the networking equipment as a superimposed status visible in the AR's FOV. Additionally, the device of the present disclosure can also eliminate the requirement of the LEDs for the switches, access points, and other networking equipment. This can lead to saving overall manufacturing costs, reducing the number of manufacturing steps, and reducing the ecological and environmental footprint by reducing components and materials such as light pipe plastics, resistors, LEDs, or the like.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

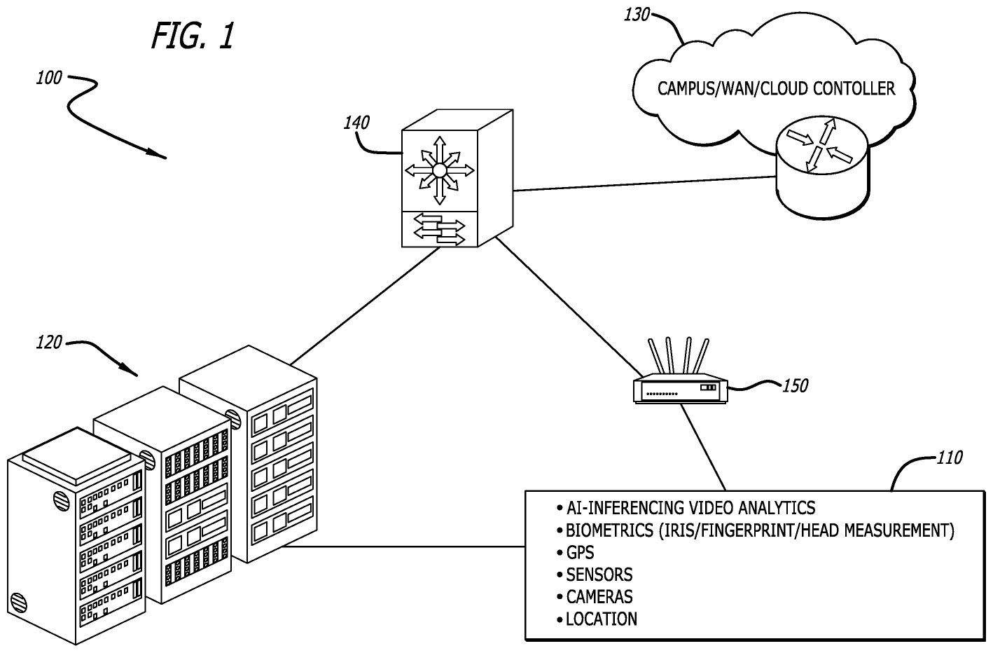

Referring to FIG. 1, a conceptual illustration of a network 100, in accordance with various embodiments of the disclosure is shown. In many embodiments, the network 100 may include an Augmented Reality (AR) device 110 and a device 120. The device 120 may be in communication with a cloud controller 130 via a switch 140. The AR device 110 can also be in communication with the cloud controller 130 via an Access Point (AP) 150 and the switch 140.

In a number of embodiments, the AR device 110 can implement an AR process. The AR device 110 may include cameras, biometric sensors, Global Positioning System (GPS) sensors, Wi-Fi chip, and may implement Artificial Intelligence (AI) video analytics. The AR device 110 can receive an image from the camera. The image may depict the device 120. The AR device 110 can detect the device 120 in the image. In that, the AR device 110 may detect one or more pixels in the image corresponding to the device 120 by implementing one or more image processing, object recognition, or computer vision techniques, for example. The AR device 110 can determine device position data, including a position and an orientation, of the AR device 110. The AR device 110 may determine the position by utilizing the GPS sensors. The position can include three-dimensional coordinates, viz. x, y, z coordinates of the AR device 110. The AR device 110 may determine the orientation by utilizing an Inertial Measurement Unit (IMU) sensor. The orientation can include three-dimensional angular coordinates, viz. Ox, Oy, 02 angular coordinates of the AR device 110. Further, the AR device 110 can determine spatial coordinates associated with the one or more pixels corresponding to the device 120 based on the device position data and image characteristics, such as but not limited to, focal length, resolution, etc. of the image. The AR device 110 may determine object position data corresponding to the device 120 based on the spatial coordinates associated with the one or more pixels. In some embodiments, for example, the object position data may indicate three-dimensional coordinates associated with the device 120. The AR device 110 may transmit an identification request to an object identification database. The identification request can include the device position data and/or the object position data. The object identification database may transmit identification data to the AR device 110 in response to the identification request. The AR device 110 can determine a device identifier associated with the device 120 based on the identification data. The AR device 110 may identify a controller associated with the device 120 based on the identification data. In some embodiments, the controller may be the cloud controller 130. The AR device 110 can transmit a status request to the cloud controller 130. The status request may include the device identifier associated with the device 120. The cloud controller 130 can provide control data associated with the device 120. The AR device 110 may superimpose the control data on the image to generate an augmented image. The AR device 110 can display the augmented image to a user.

In various embodiments, the AR device 110 may receive biometric data of the user from the biometric sensor. The AR device 110 can authenticate the user based on the biometric data. The AR device 110 may transmit an access control request to an administrative database. The access control request may include a user identifier corresponding to the user. The administrative database can transmit access control data in response to the access control request. The AR device 110 may determine which control data is authorized to be displayed to the user based on the access control data. The AR device 110 can selectively superimpose the control data on the image based on the access control data.

In additional embodiments, the AR device 110 can receive an input from the user. The AR device 110 may generate a control signal based on the input. The AR device 110 can transmit the control signal to the device 120. In more embodiments, the AR device 110 can utilize AI or Machine Learning (ML) techniques to detect or identify the objects or electronic devices, to identify relevant control data, or to generate the augmented image.

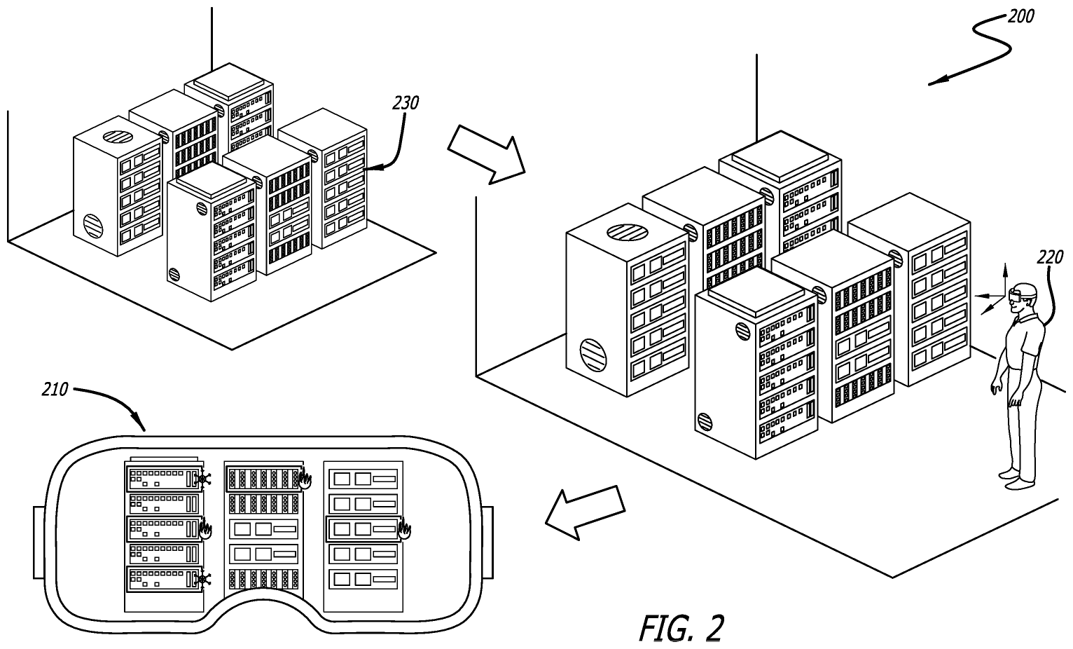

Although a specific embodiment for the network 100 for carrying out the various steps, processes, methods, and operations described herein is discussed with respect to FIG. 1, any of a variety of systems and/or processes may be utilized in accordance with embodiments of the disclosure. For example, the AR device 110 may be utilized to control and manage the device 120. The elements depicted in FIG. 1 may also be interchangeable with other elements of FIGS. 2-9 as required to realize a particularly desired embodiment.

Referring to FIG. 2, a conceptual illustration of an AR device 210, in accordance with various embodiments of the disclosure is shown. In many embodiments, the AR device 210 can be AR smart glasses. The AR device 210 may be worn by a user 220. The AR device 210 can capture an image 230 indicative of one or more objects or devices. The AR device 210 can determine device position data, including the position and the orientation, of the AR device 210. The AR device 210 may determine the position including three-dimensional coordinates, viz. x, y, z coordinates as shown in FIG. 2. The AR device 210 may also determine the orientation including three-dimensional angular coordinates, viz. θₓ, θ_{y}, θ_{z} angular coordinates as shown in FIG. 2.

In a number of embodiments, the AR device 210 may be utilized in a data center or a server room, or outdoors. The image 230, as shown in FIG. 2, may depict one or more switches mounted in stacks. Multiple stacks of switches may be located side by side. The switches and connections between the switches may look similar and complex. Therefore, it may be difficult for the user 220 to manually distinguish between the switches and identify the controllers associated with the switches. However, the AR device 210 can detect the switches, identify the switches and the corresponding controllers, and display relevant information related to the switches by way of the augmented image displayed in the AR device 210. Therefore, the AR device 210 may simplify the process of controlling, maintaining, and managing the switches.

Although a specific embodiment for the AR device 210 for carrying out the various steps, processes, methods, and operations described herein is discussed with respect to FIG. 2, any of a variety of systems and/or processes may be utilized in accordance with embodiments of the disclosure. For example, the AR device 210 may be utilized in digital infrastructures including a large number of interconnected devices. The elements depicted in FIG. 2 may also be interchangeable with other elements of FIG. 1 and FIGS. 3-9 as required to realize a particularly desired embodiment.

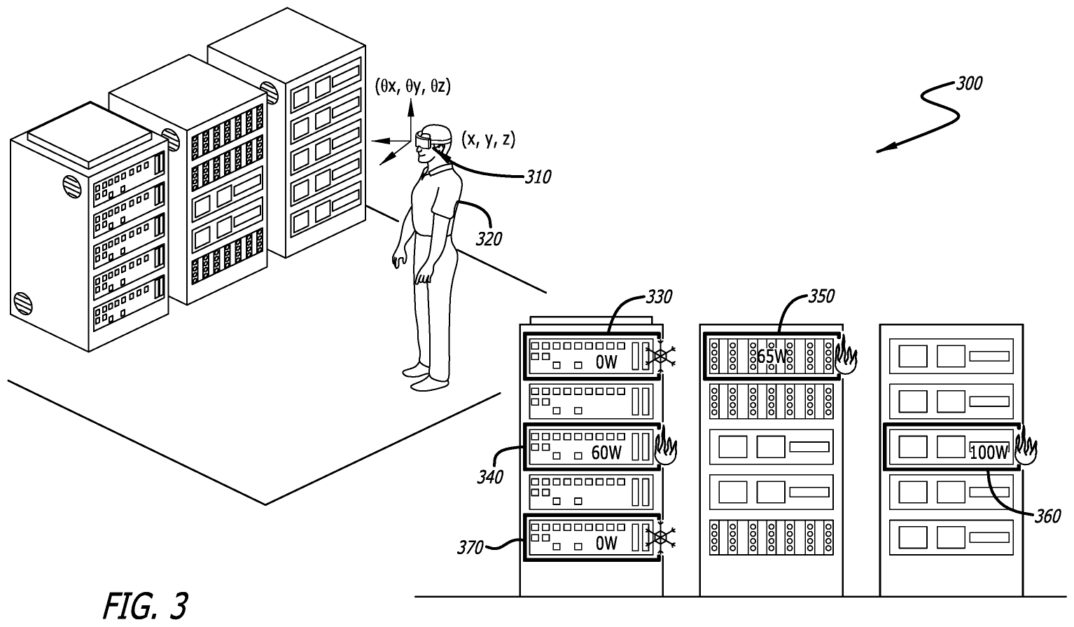

Referring to FIG. 3, a conceptual illustration of an AR view in an AR device 310, in accordance with various embodiments of the disclosure is shown. In many embodiments, the AR device can be worn by the user 320. The AR device 310 can determine the device position data. The device position data may include spatial data, including the position of the AR device 310 and the orientation of the AR device 310. For the position of the AR device 310, the device position data may include three-dimensional coordinates, viz. x, y, z coordinates of the AR device 310. In some embodiments, for example, the x, y, z coordinates can indicate the position of the AR device 310 in an indoor space, such as a room. In still more embodiments, the x, y, z coordinates can indicate the position of the AR device 310 in an outdoor space. For the orientation of the AR device 310, the device position data may include three-dimensional angular coordinates, viz. θₓ, θ_{y}, θ_{z} angular coordinates of the AR device 310. In certain embodiments, for example, the θₓ, θ_{y}, θ_{z} angular coordinates can indicate the orientation, i.e., angles made by the AR device 310 along x, y, z axes. In more embodiments, the AR device 310 may determine the device position data by utilizing Wi-Fi positioning techniques such as trilateration/multilateration, Received Signal Strength Indication (RSSI) of Radio Frequency (RF) signals, Ultra-Wideband (UWB) positioning, fingerprinting, Angle of Arrival (AoA) or Time of Flight (ToF) etc. In some more embodiments, the AR device 310 can determine the device position data based on data received from the IMU, for example. The orientation of the AR device 310 may be indicative of a direction of a gaze of the user 320 wearing the device. The image may be indicative of a Field of View (FOV) visible to the user 320. For example, in FIG. 3, the x, y, z coordinates may be indicative of which stack of switches are being viewed by the user 320 and the θₓ, θ_{y}, θ_{z} angular coordinates may be indicative of which switches within the stack are being viewed by the user 320.

In a number of embodiments, the AR device 310 can detect the first through fifth devices 330, 340, 350, 360, and 370 in the FOV of the user 320. In some embodiments, the AR device 310 can also identify connections, such as wires, between the first through fifth devices 330, 340, 350, 360, and 370. The AR device 310 may further identify the first through fifth devices 330, 340, 350, 360, and 370 and the controllers associated with the first through fifth devices 330, 340, 350, 360, and 370. In certain embodiments, for instance, each device of the first through fifth devices 330, 340, 350, 360, and 370 may be associated with a different controller. The AR device 310 can retrieve the control data associated with each device of the first through fifth devices 330, 340, 350, 360, and 370. In more embodiments, the control data, as shown in FIG. 3, may be indicative of the power consumption of the first through fifth devices 330, 340, 350, 360, and 370. In more examples, the control data may be indicative of whether the first through fifth devices 330, 340, 350, 360, and 370 arc ON/OFF or in a power saving mode, or whether the first through fifth devices 330, 340, 350, 360, and 370 are online/offline, etc. For the connectors or cables, the control data may indicate whether the connection is proper or functional, a speed of the connection, quality of the connection, etc. The AR device 310 may superimpose the control data on the image to generate the augmented image. The AR device 310 may utilize image processing or computer vision techniques to display the control data adjacent to locations of corresponding first through fifth devices 330, 340, 350, 360, and 370 in the image. For example, as shown in FIG. 3, the control data may be displayed in form of boxes enclosing the corresponding first through fifth devices 330, 340, 350, 360, and 370 with an indication of power consumption or temperature of the first through fifth devices 330, 340, 350, 360, and 370. The AR device 310 can display the augmented image to the user 320.

Although a specific embodiment for the AR device 310 for carrying out the various steps, processes, methods, and operations described herein is discussed with respect to FIG. 3, any of a variety of systems and/or processes may be utilized in accordance with embodiments of the disclosure. For example, the AR device 310 may identify and display relevant control data in a dynamic and interactive format. The elements depicted in FIG. 3 may also be interchangeable with other elements of FIGS. 1-2 and FIGS. 4-9 as required to realize a particularly desired embodiment.

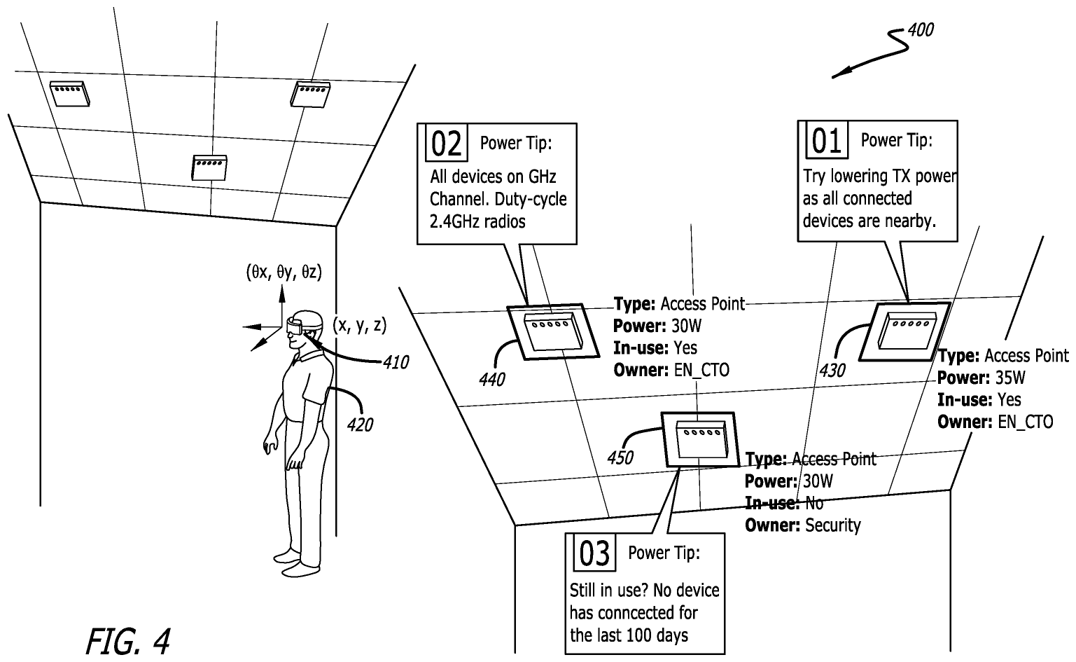

Referring to FIG. 4, a conceptual illustration of the position and the orientation of an AR device 410, in accordance with various embodiments of the disclosure is shown. In many embodiments, the AR device 410 can be utilized to inspect first through third ceiling mounted devices 430, 440, and 450 (also referred to as first through third devices 430, 440, and 450 with reference to FIG. 4) which may be difficult to physically access by a user 420. The AR device 410 can identify the first through third devices 430, 440, and 450 and retrieve relevant control data corresponding to the first through third devices 430, 440, and 450. In some embodiments, for example, the AR device 410 may retrieve different type of control data for each device of the first through third devices 430, 440, and 450.

In a number of embodiments, for example, the AR device 410 may suggest possible actions based on the control data corresponding to the first through third devices 430, 440, and 450. For instance, for the first device 430, the AR device 410 may display the control data such as type, power consumption, operational status, and owner of the first device 430. The AR device 410 may utilize AI/ML techniques to generate a first suggested action corresponding to the first device 430 based on the control data. For instance, as shown in FIG. 4, the AR device 410 may provide the first suggestion of reducing transmission power of the first device 430 as one or more user devices connected to the first device 430 are located at short distances. The first suggestion may be an interactive display element that facilitates the user 420 to generate a first control signal indicative of reducing transmission power of the first device 430. Upon receiving the input from the user 420, the AR device 410 may generate and transmit the first control signal to the first device 430. Similarly, the AR device 410 may display the control data such as type, power consumption, operational status, and owner of the second device 440. The AR device 410 may utilize AI/ML techniques to generate a second suggested action corresponding to the second device 440 based on the control data. For instance, as shown in FIG. 4, the AR device 410 may provide the second suggestion of switching the second device 440 to 5 GHz Wi-Fi band as all user devices connected to the second device 440 are connected on the 5 GHz band. The second suggestion may also be an interactive display element that facilitates the user 420 to generate a second control signal indicative of switching the second device 440 to 5 GHz Wi-Fi band. Upon receiving the input from the user 420, the AR device 410 may generate and transmit the second control signal to the second device 440. Similarly, the AR device 410 may display the control data such as type, power consumption, operational status, and owner of the third device 450. The AR device 410 may utilize AI/ML techniques to generate a third suggested action corresponding to the third device 450 based on the control data. For instance, as shown in FIG. 4, the AR device 410 may provide the third suggestion of switching off the third device 450 as no user devices have connected to the third device 450 for a long period of time, i.e., the third device 450 is not being used. The third suggestion can also be an interactive display element that facilitates the user 420 to generate a third control signal indicative of switching off the third device 450. Upon receiving the input from the user 420, the AR device 410 may generate and transmit the third control signal to the third device 450.

Although a specific embodiment for the AR device 410 for carrying out the various steps, processes, methods, and operations described herein is discussed with respect to FIG. 4, any of a variety of systems and/or processes may be utilized in accordance with embodiments of the disclosure. For example, the AR device 410 may intelligently generate and display suggestions or possible actions that can be implemented for the detected devices. The elements depicted in FIG. 4 may also be interchangeable with other elements of FIGS. 1-3 and FIGS. 5-9 as required to realize a particularly desired embodiment.

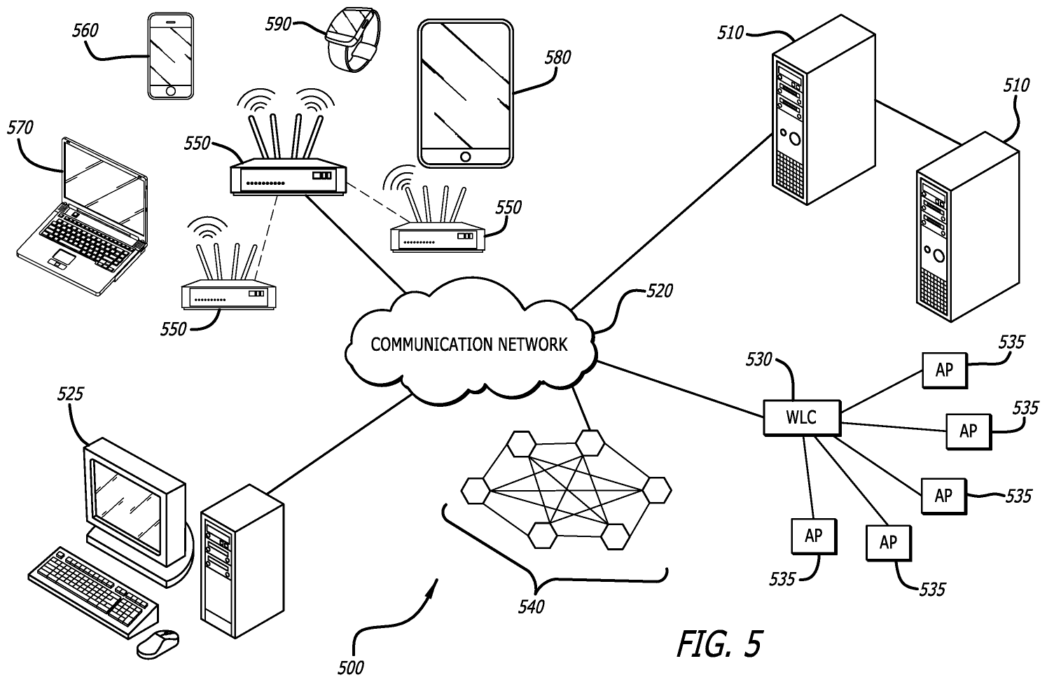

Referring to FIG. 5, a conceptual network diagram 500 of various environments that an AR device manager may operate on a plurality of network devices, in accordance with various embodiments of the disclosure is shown. Those skilled in the art will recognize that the AR device manager can be comprised of various hardware and/or software deployments and can be configured in a variety of ways. In many embodiments, the AR device manager can be configured as a standalone device, exist as a logic in another network device, be distributed among various network devices operating in tandem, or remotely operated as part of a cloud-based network management tool. In further embodiments, one or more servers 510 can be configured with or otherwise operate the AR device manager. In many embodiments, the AR device manager may operate on one or more servers 510 connected to a communication network 520. The communication network 520 can include wired networks or wireless networks. In many embodiments, the communication network 520 may be a Wi-Fi network operating on various frequency bands, such as, 2.4 GHZ, 5 GHZ, or 6 GHz. In further embodiments, the AR device manager may operate on the servers 510. The AR device manager can be provided as a cloud-based service that can service remote networks, such as, but not limited to a deployed network 540. In many embodiments, the AR device manager can be a logic that detects and controls one or more devices or network devices by utilizing AR techniques.

However, in additional embodiments, the AR device manager may be operated as a distributed logic across multiple network devices. In the embodiment depicted in FIG. 5, a plurality of APs 550 can operate as the AR device manager in a distributed manner or may have one specific device operate as the AR device manager for all of the neighboring or sibling APs 550. The APs 550 facilitate Wi-Fi connections for various electronic devices, such as but not limited to mobile computing devices including laptop computers 570, cellular phones 560, portable tablet computers 580 and wearable computing devices 590.

In further embodiments, the AR device manager may be integrated within another network device. In the embodiment depicted in FIG. 5, a wireless LAN controller (WLC) 530 may have an integrated AR device manager that the WLC 530 can use to control and manage various APs 535 that the WLC 530 is connected to, either wired or wirelessly. In still more embodiments, a personal computer 525 may be utilized to access and/or manage various aspects of the AR device manager, either remotely or within the network itself. In the embodiment depicted in FIG. 5, the personal computer 525 communicates over the communication network 520 and can access the AR device manager of the servers 510, or the network APs 550, or the WLC 530.

Although a specific embodiment for various environments that the AR device manager may operate on a plurality of network devices suitable for carrying out the various steps, processes, methods, and operations described herein is discussed with respect to FIG. 5, any of a variety of systems and/or processes may be utilized in accordance with embodiments of the disclosure. In many non-limiting examples, the AR device manager may be provided as a device or software separate from the network devices or the AR device manager may be integrated into the network devices. The elements depicted in FIG. 5 may also be interchangeable with other elements of FIGS. 1-4 and 6-9 as required to realize a particularly desired embodiment.

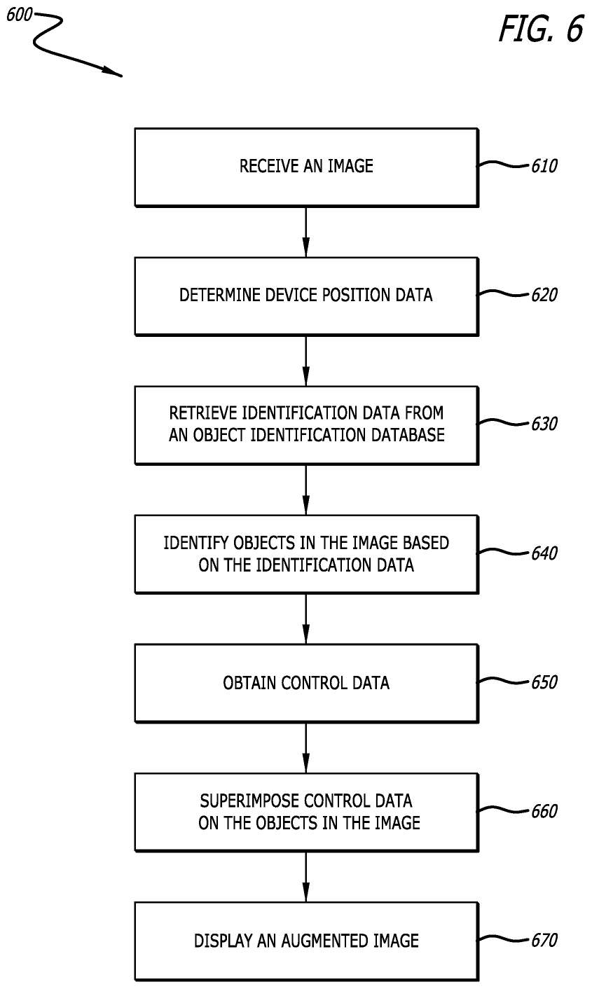

Referring to FIG. 6, a flowchart depicting a process 600 for displaying the augmented image, in accordance with various embodiments of the disclosure is shown. In many embodiments, the process 600 can receive the image (block 610). In some embodiments, the process 600 may be an AR device management process. In certain embodiments, the process 600 can be implemented by the AR device. In further embodiments, examples of the AR device can include, but are not limited to, smart glasses, AR glasses, AR sets, AR goggles, or head mounted displays, etc. In more embodiments, the process 600 may be implemented by various types of devices, such as but not limited to, a smartphone, a tablet, or a personal computer etc. In some more embodiments, the devices may be equipped with a camera to capture the image or to capture videos, in real-time or near-real time. In numerous embodiments, the process 600 may receive the image from an external source or an external device. In many further embodiments, the process 600 can retrieve the image from an internal memory or fetch the image from an external database. In still more embodiments, the image can be a frame in a video feed. In many additional embodiments, the image may depict one or more objects. In still further embodiments, examples of the objects may include network devices, such as but not limited to, switches, routers, or gateways, etc. In still more embodiments, more examples of the objects can also include connections between the devices, such as but not limited to, wires, cables, or optical fibers, etc. In many further embodiments, further examples of the objects may include equipment or appliances, such as but not limited to, light bulbs, displays (for example, televisions or monitors), ceiling mounted devices such as projectors or smoke detectors, air conditioning systems, HVACs, or Wi-Fi Access Points (APs), etc. In still more embodiments, the objects can be Radio Frequency Identification (RFID) tags, Near-Field Communication (NFC) tags, QR codes, Bluetooth Low Energy (BLE) beacons, or barcodes etc. In many additional embodiments, some more examples of the objects may include, but are not limited to, power supplies, wall plugs/outlets, generators, or batteries etc.

In a number of embodiments, the process 600 may determine the device position data (block 620). In some embodiments, the device position data may include spatial data, including the position of the AR device and the orientation of the AR device. In further embodiments, for the position of the device, the device position data may include three-dimensional coordinates, viz. x, y, z coordinates of the AR device. In certain embodiments, for example, the x, y, z coordinates can indicate the position of the AR device in an indoor space, such as a room. In still more embodiments, the x, y, z coordinates can indicate the position of the AR device in an outdoor space. In still further embodiments, for the orientation of the device, the device position data may include three-dimensional angular coordinates, viz. θₓ, θ_{y}, θ_{z} angular coordinates of the AR device. In more embodiments, for example, the θₓ, θ_{y}, θ_{z} angular coordinates can indicate the orientation, i.e., angles made by the AR device along x, y, z axes. In some more embodiments, the process 600 may determine the device position data by utilizing Wi-Fi positioning techniques such as trilateration/multilateration, RSSI fingerprinting, UWB positioning, AoA or ToF etc. In numerous embodiments, the process 600 can determine the device position data based on data received from the IMU, for example. In many further embodiments, for wearable devices, the orientation of the AR device may be indicative of the direction of the gaze of the user wearing the AR device. In still more embodiments, in that case, the image may be indicative of the FOV visible to the user. In many further embodiments, the process 600 may detect one or more pixels in the image corresponding to the objects by implementing one or more image processing, object recognition, or computer vision techniques, for example. In some embodiments, the process 600 can determine spatial coordinates associated with the one or more pixels based on the device position data and image characteristics of the image. In certain embodiments, examples of the image characteristics may include focal length, resolution, etc. of the image. In more embodiments, the process 600 may determine object position data based on the spatial coordinates associated with the one or more pixels corresponding to the objects. In some more embodiments, for example, the object position data may indicate three-dimensional coordinates associated with the objects.

In various embodiments, the process 600 can retrieve the identification data from the object identification database (block 630). In some embodiments, the process 600 can identify the objects by accessing the object dentification database. In certain embodiments, the object identification database may include a mapping of the objects and their locations. In more embodiments, the process 600 can transmit the identification request to the object identification database. In some more embodiments, the identification request may include the device position data and/or the object position data. In numerous embodiments, the object identification database can retrieve the object identifiers of the objects present in an area of space associated with the device position data and/or the object position data. In many further embodiments, the object identification database may transmit the identification data to the process 600 implemented by the AR device. In still more embodiments, the identification data may include information, such as but not limited to object identifiers, types of objects, or controllers associated with the objects, etc. In many additional embodiments, the process 600 can identify the objects based on the identification data. In still further embodiments, the process 600 may also identify the objects by scanning or processing QR codes, BLE beacons, barcodes, RFID tags, or NFC tags associated with the objects.

In additional embodiments, the process 600 can identify the objects in the image based on the identification data (block 640). In some embodiments, the process 600 can determine the controllers associated with the objects (or electronic devices) based on the identification data. In certain embodiments, for instance, when the object is a switch or a database, the process 600 can determine the server or cloud server that is connected to the switch or the database. In more embodiments, the AR device implementing the process 600 may be connected to the controllers by way of wired or wireless networks.

In further embodiments, the process 600 may obtain the control data (block 650). In some embodiments, the process 600 can communicate with the controllers through internet. In certain embodiments, the process 600 can transmit the status request to the controller associated with the electric device. In some more embodiments, for example, the status request may include an identifier (for example, IP address or MAC address) associated with the electronic device, name of the electronic device, type of the electronic device, or other information indicated by the identification data corresponding to the electronic device. In numerous embodiments, the controller may transmit control data to the process 600 implemented by the AR device in response to the status request. In many further embodiments, the control data can be indicative of one or more parameters associated with the electronic device, such as but not limited to, power consumption, status (for example, whether the electronic device is ON/OFF or in a power saving mode, whether the device is online/offline, etc.), or other such parameters relevant to the electronic device.

In many more embodiments, the process 600 can superimpose the control data on the objects in the image (block 660). In some embodiments, the process 600 may utilize image processing or computer vision techniques to display the control data adjacent to the location of the electronic device in the image. In certain embodiments, the process 600 can generate the augmented image including the objects and the corresponding control data.

In many additional embodiments, the process 600 may display the augmented image (block 670). In some embodiments, the augmented image can be displayed in real-time or near-real time. In certain embodiments, the process 600 may display the augmented image in an interactive format, thereby allowing the user to select or interact with the objects and/or the control data.

Although a specific embodiment for the process 600 for displaying the augmented image for carrying out the various steps, processes, methods, and operations described herein is discussed with respect to FIG. 6, any of a variety of systems and/or processes may be utilized in accordance with embodiments of the disclosure. For example, the process 600 may be utilized to directly interact with Internet of Things (IoT) enabled devices or with devices powered by Power over Ethernet (PoE). The elements depicted in FIG. 6 may also be interchangeable with other elements of FIGS. 1-5 and FIGS. 7-9 as required to realize a particularly desired embodiment.

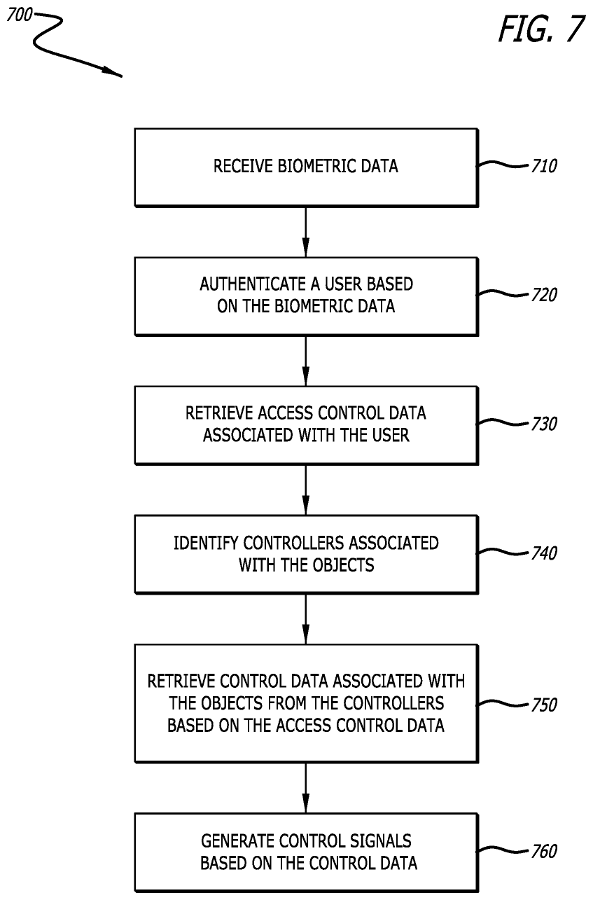

Referring to FIG. 7, a flowchart depicting a process 700 for generating the control signals, in accordance with various embodiments of the disclosure is shown. In many embodiments, the process 700 can receive the biometric data (block 710). In some embodiments, the process 700 may be implemented by the AR device comprising the biometric sensors, such as but not limited to a face recognition sensor, an iris recognition sensor, or a fingerprint sensor, etc. In certain embodiments, the biometric data may be generated by the biometric sensors when the user wears, handles, or interacts with the device.

In a number of embodiments, the process 700 may authenticate the user based on the biometric data (block 720). In some embodiments, the process 700 may determine the user identifier (for example, name, username, or ID number) corresponding to the user. In certain embodiments, the process 700 can uniquely identify and authenticate different users using the same AR device.

In various embodiments, the process 700 can retrieve the access control data associated with the user (block 730). In some embodiments, the process 700 can further access the administrative database to determine the level of access authorized to the user. In certain embodiments, the administrative database may include user identifiers and corresponding authorizations, for example, access levels, etc. In more embodiments, the process 700 can transmit the access control request to the administrative database. In some more embodiments, the access control request may be indicative of the user identifier. In numerous embodiments, the administrative database can transmit the access control data in response to the access control request.

In additional embodiments, the process 700 may identify the controllers associated with the objects (block 740). In some embodiments, the process 700 can identify the controllers based on the identification data. In certain embodiments, the process 700 may transmit the status request to the controller. In more embodiments, the status request may be indicative of the object identifier. In some more embodiments, the controller may transmit the control data associated with the object.

In further embodiments, the process 700 can retrieve the control data associated with the objects from the controllers based on the access control data (block 750). In some embodiments, the access control data may be indicative of the portion of control data that is authorized to be accessed by the user. In certain embodiments, the process 700 can select the portion of the control data that can be accessed by the user and superimpose the selected control data on the image to generate the augmented image.

In many more embodiments, the process 700 may generate the control signals based on the control data (block 760). In some embodiments, the process 700 may receive the input from the user. In certain embodiments, for example, the process 700 may receive the voice command, the gesture, or the touch, etc. from the user as the input. In more embodiments, the process 700 can generate the control signals based on the input received from the user. In numerous embodiments, when the objects are the electronic devices, the control signals may be indicative of changing the operational states (such as power saving modes, for example) of the electronic devices, switching the electronic devices ON/OFF, etc. In many further embodiments, the control signals can be indicative of changing power policies of the electronic devices.

Although a specific embodiment for the process 700 for generating the control signals for carrying out the various steps, processes, methods, and operations described herein is discussed with respect to FIG. 7, any of a variety of systems and/or processes may be utilized in accordance with embodiments of the disclosure. For example, the process 700 may be utilized for wirelessly generating the control signals through the AR device. The elements depicted in FIG. 7 may also be interchangeable with other elements of FIGS. 1-6 and FIGS. 8-9 as required to realize a particularly desired embodiment.

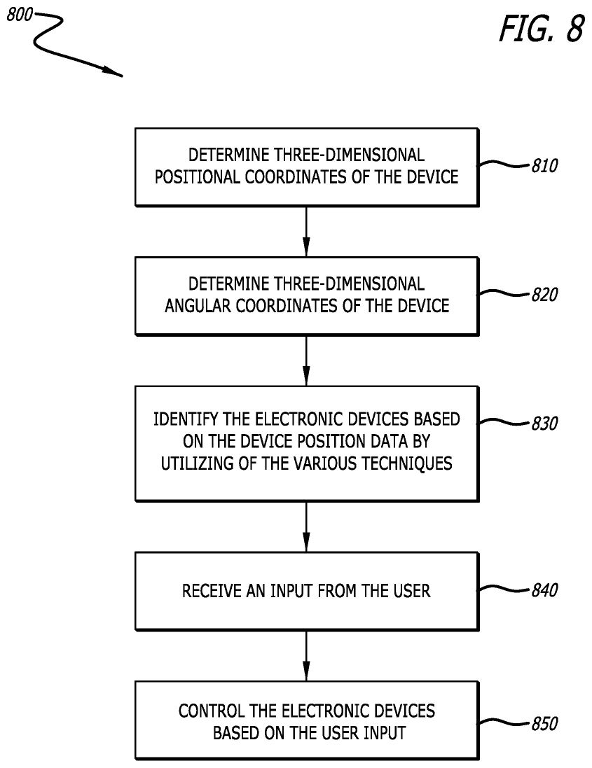

Referring to FIG. 8, a flowchart depicting a process 800 for controlling the electronic devices, in accordance with various embodiments of the disclosure is shown. In many embodiments, the process 800 may determine the three-dimensional positional coordinates, viz. x, y, z coordinates of the AR device (block 810). In some embodiments, the process 800 can be implemented by the AR device. In certain embodiments, the process 800 may utilize the Wi-Fi positioning techniques such as trilateration/multilateration, RSSI fingerprinting, UWB positioning, AoA, or ToF etc. In more embodiments, the process 800 can determine the position of the AR device in the indoor space, such as the room, or any outdoor space.

In a number of embodiments, the process 800 can determine the three-dimensional angular coordinates of the AR device (block 820). In some embodiments, the process 800 can determine the device position data based on the data received from IMU, for example. In certain embodiments, for example, the θₓ, θ_{y}, θ_{z} angular coordinates can indicate the orientation, i.e., angles made by the AR device along x, y, z axes.

In various embodiments, the process 800 may identify the electronic devices based on the device position data by utilizing of the various techniques (block 830). In some embodiments, the process 800 can identify the electronic devices by obtaining the identification data from the object identification database. In certain embodiments, the process 800 may also identify the objects by scanning or processing barcodes, QR codes, RFID tags, or NFC tags associated with the objects.

In additional embodiments, the process 800 can receive the input from the user (block 840). In some embodiments, the process 800 may receive the input when the user interacts with the interactive augmented image. In certain embodiments, the process 800 can receive the voice command, the gesture, or the touch, etc. from the user as the input.

In further embodiments, the process 800 may control the electronic devices based on the user input (block 850). In some embodiments, the process 800 can generate the control signals based on the input. In certain embodiments, the process 800 may transmit the control signals to the electronic device.

Although a specific embodiment for the process 800 for controlling the electronic devices for carrying out the various steps, processes, methods, and operations described herein is discussed with respect to FIG. 8, any of a variety of systems and/or processes may be utilized in accordance with embodiments of the disclosure. For example, the process 800 may wirelessly control the electronic devices. The elements depicted in FIG. 8 may also be interchangeable with other elements of FIGS. 1-7 and FIG. 9 as required to realize a particularly desired embodiment.

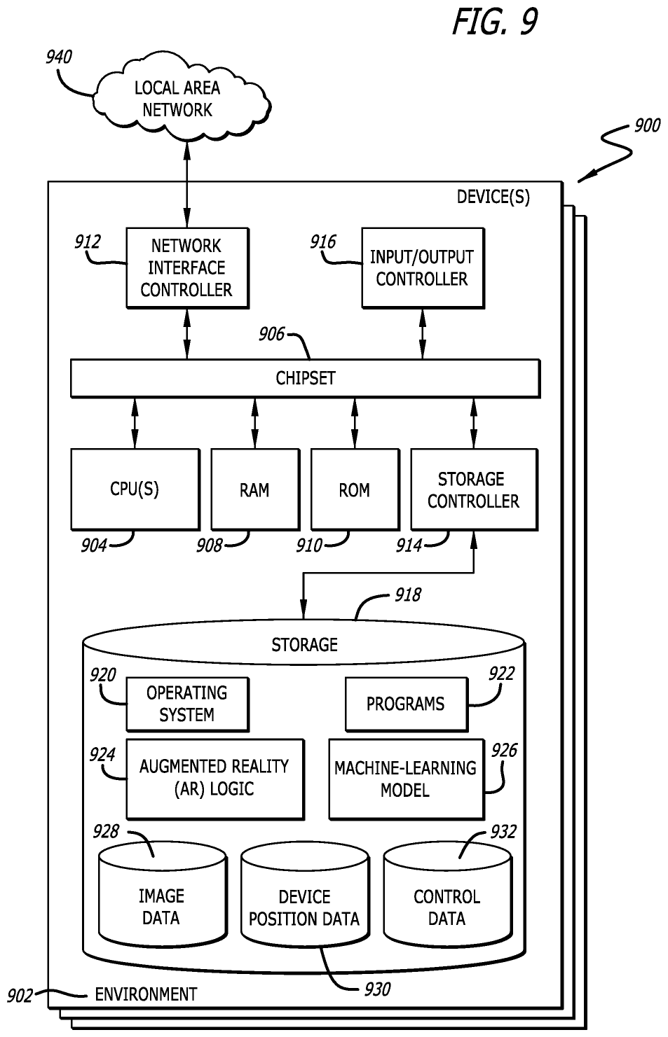

Referring to FIG. 9, a conceptual block diagram of a device 900 suitable for configuration with an augmented reality logic, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, image data 928, device position data 930, and control data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The image data 928 can include the images obtained by the camera coupled with the device 900. The image data 928 can also include the augmented images generated by the device 900. The device position data 930 may store the position and orientation of the device 900. The control data 932 can store the control data associated with the objects in the image. The control data 932 can be received by the device 900 from the controllers associated with the objects.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to the device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include an augmented reality logic 924. The augmented reality logic 924 can be configured to perform one or more of the various steps, processes, operations, and/or other methods that are described above. Often, the augmented reality logic 924 can be a set of instructions stored within a non-volatile memory that, when executed by the processor(s)/controller(s) 904 can carry out these steps, etc. In some embodiments, the augmented reality logic 924 may be a client application that resides on a network-connected device, such as, but not limited to, a server, switch, personal or mobile computing device in a single or distributed arrangement. The augmented reality logic 924 can generate the augmented images based on the captured images, the control data, and the access data.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the image data 928, the device position data 930, and the control data 932 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for the device 900 suitable for configuration with the augmented reality logic 924 for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

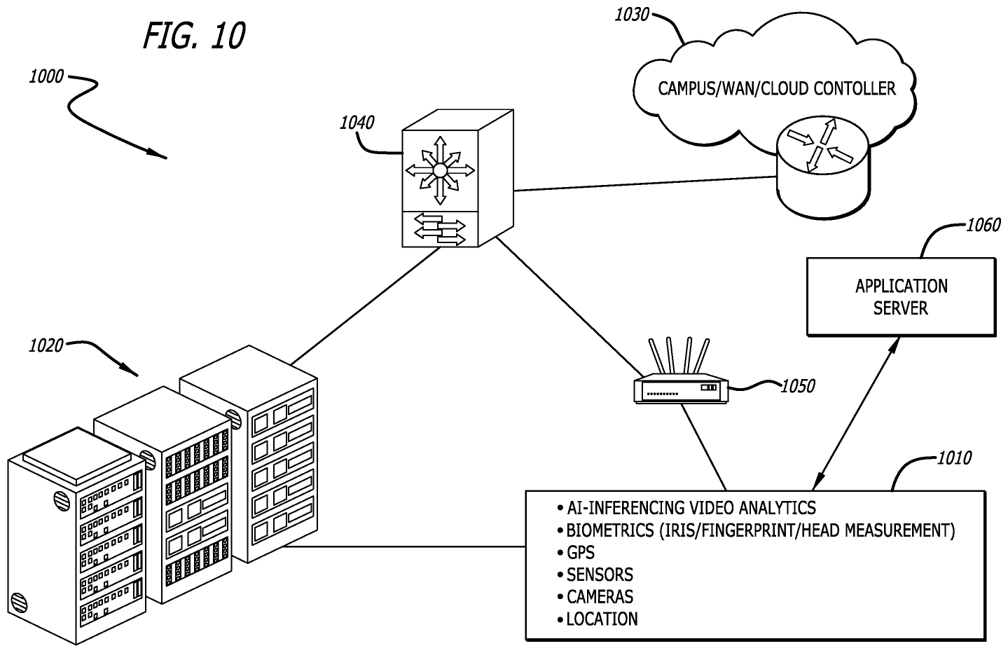

Referring to FIG. 10, a conceptual illustration of a network 1000 in accordance with various embodiments of the disclosure is shown. In many embodiments, the network 1000 may include an AR device 1010 and a device 1020 (e.g., an object). The device 1020 may be in communication with a cloud controller 1030 via a switch 1040. The AR device 1010 can also be in communication with the cloud controller 1030 via an Access Point (AP) 1050 and the switch 1040. The AR device 1010 may also be communicatively connected to an application server 1060.

In a number of embodiments, the AR device 1010 can implement an AR process. The AR device 1010 may include cameras, biometric sensors, Global Positioning System (GPS) sensors, Wi-Fi chip, and may implement Artificial Intelligence (AI) video analytics. The AR device 1010 can receive an image from the camera. The image may depict the device 1020. For example, the image may depict switches, routers, APs, or other such networking equipment. The AR device 1010 may determine the position by utilizing the GPS sensors. The position can include three-dimensional coordinates, viz. x, y, z coordinates of the AR device 1010. The AR device 1010 may determine the orientation by utilizing an Inertial Measurement Unit (IMU) sensor. The orientation can include three-dimensional angular coordinates, viz. θₓ, θ_{y}, θ_{z} angular coordinates of the AR device 1010.

In a variety of embodiments, the AR device 1010 may transmit the image and the position data to the application server 1060. The application server 1060 may identify the device 1020 in the received image. For example, the application server 1060 may detect one or more pixels in the image corresponding to the device 1020 by implementing one or more image processing, object recognition, or computer vision techniques. In some embodiments, the application server 1060 can determine spatial coordinates associated with the one or more pixels corresponding to the device 1020 based on the device position data and image characteristics, such as but not limited to, focal length, resolution, etc. of the image. The application server 1060 may determine position data for one or more objects corresponding to the device 1020 based on the spatial coordinates associated with the one or more pixels. For example, the application server 1060 may determine the spatial coordinates for one or more ports corresponding to a switch identified in the image.

In numerous embodiments, the application server 1060 may transmit an identification request to an object identification database. The identification request can include the device position data and/or the object position data. The object identification database may transmit identification data to the application server 1060 in response to the identification request. The application server 1060 can determine a device identifier associated with the device 1020 based on the identification data. The application server 1060 can determine object identifiers associated with the one or more objects corresponding to the device 1020 based on the identification data. The application server 1060 may identify a controller associated with the device 1020 and/or the objects corresponding to the device 1020 based on the identification data. In more embodiments, the controller may be the cloud controller 1030.

In certain embodiments, the application server 1060 can transmit a status request to the cloud controller 1030. The status request may include the device identifier associated with the device 1020 and/or the objects corresponding to the device 1020. In response to the status request, the cloud controller 1030 may provide status data associated with the device 1020 and/or the corresponding objects of the device 1020 to the application server 1060. The application server 1060 may generate overlay data associated with the image based on the received status data. The overlay data may refer to any digital content or additional information that can be superimposed onto the FOV of a user through an AR display device or that can facilitate generation of an augmented overlay for superimposition onto the FOV through the AR display device. The application server 1060 may transmit the overlay data to the AR device 1010 to enable generation of a superimposed image for the AR device display 1010.

Although a specific embodiment for the network 1000 for carrying out the various steps, processes, methods, and operations described herein is discussed with respect to FIG. 10, any of a variety of systems and/or processes may be utilized in accordance with embodiments of the disclosure. For example, the application server 1060 may use an Artificial Intelligence (AI) based model to identify the device or one or more objects visible in the image. The elements depicted in FIG. 10 may also be interchangeable with other elements of FIGS. 1-9 and 11-22 as required to realize a particularly desired embodiment.

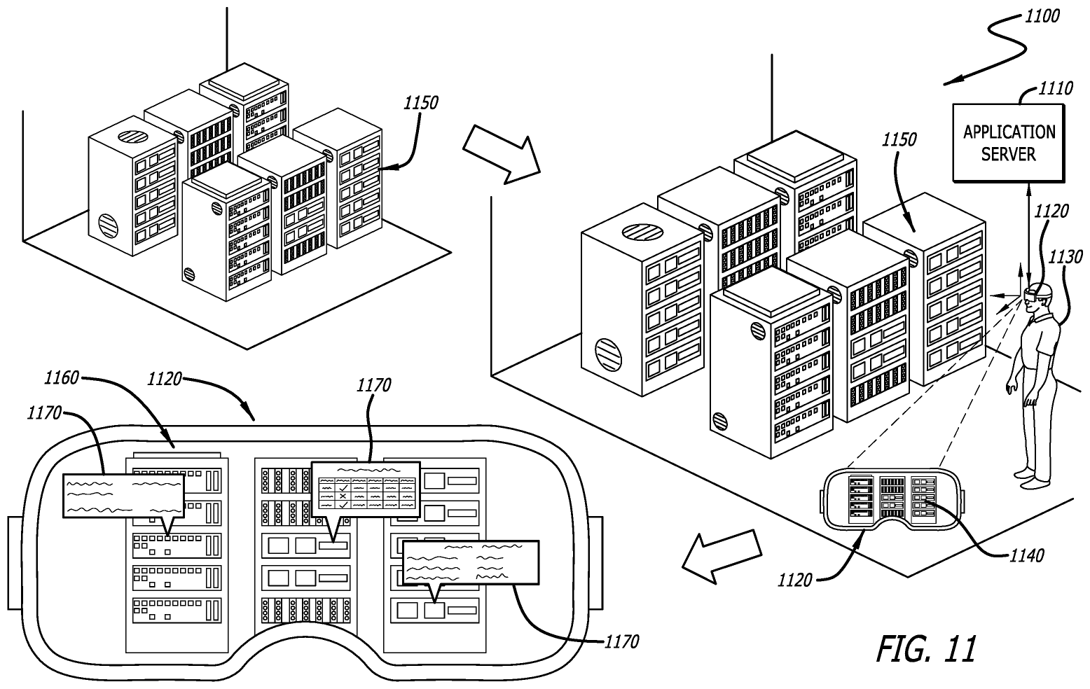

Referring to FIG. 11, a conceptual illustration 1100 of an AR process implemented via an application server 1110 and an AR device 1120 in accordance with various embodiments of the disclosure is shown. In many embodiments, the AR device 1120 is worn by a user 1130. The AR device 1120 can capture an image 1140 of one or more objects or devices 1150 visible in the FOV of the AR device 1120. The AR device 1120 can determine device position data, including the position and the orientation, of the AR device 1120. The AR device 1120 may determine the position including three-dimensional coordinates, viz. x, y, z coordinates as well as determine the orientation including three-dimensional angular coordinates, viz. Ox, Oy, Oz angular coordinates.

In a number of embodiments, the AR device 1120 may be utilized, for example, in a data center or a server room for monitoring APs, routers, or the like. As shown in the FIG. 11, the image 1140 may depict one or more switches (e.g., one or more objects or devices 1150) mounted in stacks. Multiple stacks of switches may be located side by side. The switches and connections between the switches may look similar and complex to an onlooker, for example, the user 1130. Therefore, it may be difficult for the user 1130 to manually check the status of the switches and to get detailed information regarding various ports.

In a variety of embodiments, the AR device 1120 can transmit the captured image 1140 and the device position data to the application server 1110. The application server 1110 may refer to a specific server designed to host and run programs, applications or software services. The application server 1110 can provide an environment for executing application logic, and processing client requests to generate and deliver dynamic content. The application server 1110 can detect the switches in the received image 1140, identify the switches and corresponding controllers, obtain relevant status data related to the switches, and generate overlay data for the received image 1140 based on the status data. In some of the embodiments, the overlay data may correspond to an augmented overlay including the status data. In more embodiments, the overlay data may include information, regarding placement of the status data on the image 1140, configured to facilitate generation of an augmented overlay. For example, the overlay data may include pixel coordinates of the image 1140 indicating various positions at which the status data shall be superimposed. The application server 1110 can transmit the overlay data to the AR device 1120 for presenting the status data to the user 1130 by way of an augmented image 1160 displayed in the AR device 1120.

The AR device 1120 may receive the overlay data and may generate an augmented image 1160 based on the overlay data. In certain embodiments, where the overlay data corresponds to the augmented overlay, the AR device 1120 may superimpose the overlay data onto the image 1140 to generate the augmented image 1160. In numerous embodiments, where the overlay data is configured to facilitate the generation of the augmented overlay, the AR device 1120 may generate an augmented overlay that has the status data 1170 placed at those pixel coordinates as indicated by the overlay data. The AR device 1120 may then generate the augmented image 1160 by superimposing the augmented overlay on the image 1140. For example, as shown in FIG. 11, status data 1170 is superimposed on the image 1140 to present the augmented image 1160 to the user 1130. In many examples, the status data 1170 may be related to port characteristics data, box status, uptime information, or the like. Thus, the application server 1110 and the AR device 1120 may simplify the process of controlling, maintaining, and managing the switches by providing detailed status information of specific switch or ports of a switch to the user 1130 by way of augmented images.

Although a specific embodiment for the AR process implemented via the application server 1110 and the AR device 1120 for carrying out the various steps, processes, methods, and operations described herein is discussed with respect to FIG. 11, any of a variety of systems and/or processes may be utilized in accordance with embodiments of the disclosure. For example, in numerous other embodiments, instead of the application server 1110 being a standalone device, the functionalities of the application server 1110 can be implemented by the AR device 1120. In various embodiments, the AR device 1120 may directly obtain the status data from the one or more objects. For example, the one or more objects may include an embedded BLE or a Wi-Fi chip that can transmit the status data directly to the AR device 1120. In numerous additional embodiments, the AR device 1120 may pair with the one or more objects using QR codes, RFID, NFC, or the like, without requiring any user input for selection or authentication. For example, the user may view the status information of the one or more objects without requiring special access privileges. The elements depicted in FIG. 11 may also be interchangeable with other elements of FIGS. 1-10 and FIGS. 12-22 as required to realize a particularly desired embodiment.

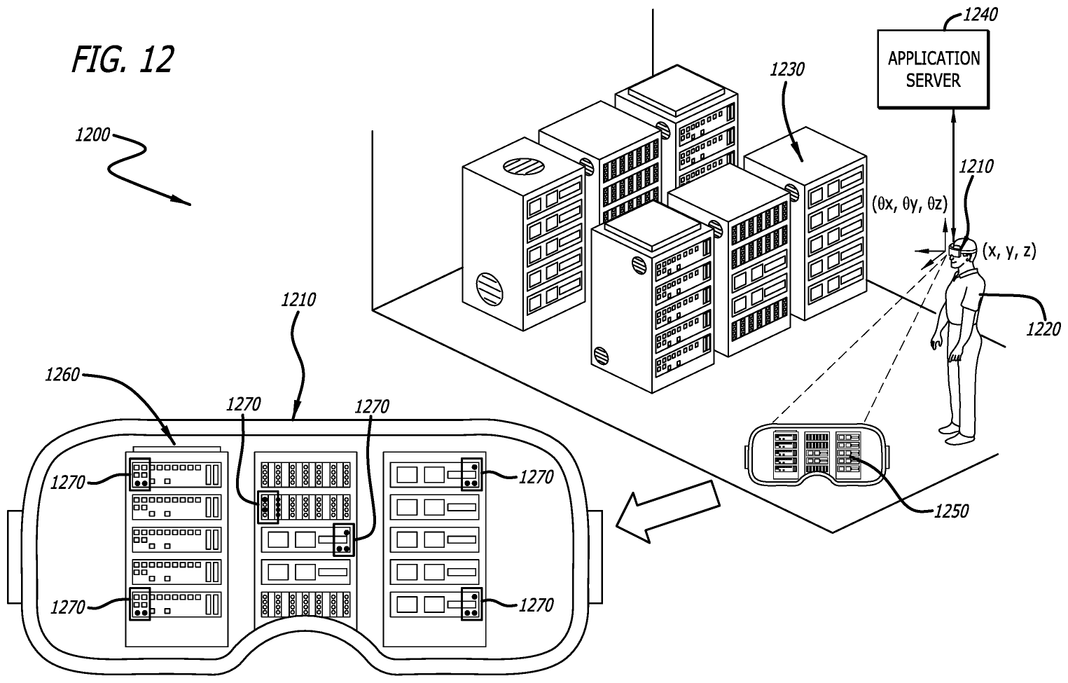

Referring to FIG. 12, a conceptual illustration 1200 of an AR view in an AR device 1210 in accordance with various embodiments of the disclosure is shown. In many embodiments, the AR device 1210 can be worn by a user 1220. The AR device 1210 can be used in a server room or a data center to view statuses of one or more objects or devices 1230. The AR device 1210 may be communicatively coupled to an application server 1240.

In numerous embodiments, the AR device 1210 can determine the device position data. The device position data may include spatial data, including a position of the AR device 1210 and an orientation of the AR device 1210. For the position of the AR device 1210, the device position data may include three-dimensional coordinates, viz. x, y, z coordinates of the AR device 1210. In a number of embodiments, for example, the x, y, z coordinates can indicate the position of the AR device 1210 in an indoor space, such as a room. In a variety of embodiments, the x, y, z coordinates can indicate the position of the AR device 1210 in an outdoor space. For the orientation of the AR device 1210, the device position data may include three-dimensional angular coordinates, viz. θₓ, θ_{y}, θ_{z} angular coordinates of the AR device 1210. In some embodiments, for example, the θₓ, θ_{y}, θ_{z} angular coordinates can indicate the orientation, for example, angles made by the AR device 1210 along x, y, z axes. In more embodiments, the AR device 1210 may determine the device position data by utilizing Wi-Fi positioning techniques such as trilateration/multilateration, Received Signal Strength Indication (RSSI) of Radio Frequency (RF) signals, Ultra-Wideband (UWB) positioning, fingerprinting, Angle of Arrival (AoA), or Time of Flight (ToF), or the like. In various embodiments, the AR device 1210 may determine the device position data by utilizing Simultaneous Localization and Mapping (SLAM) technique. In additional embodiments, the AR device 1210 can determine the device position data based on data received, for example, from the IMU. The orientation of the AR device 1210 may be indicative of a direction of a gaze of the user 1220 wearing the AR device 1210. In numerous embodiments, the AR device 1210 may determine the gaze of the user 1220 using the in-built iris scanner of the AR device 1210. An image 1250 captured by the AR device 1210 may be indicative of a Field of View (FOV) visible to the user 1220 via the AR device 1210. For example, in FIG. 12, the x, y, z coordinates may be indicative of which stack of switches are being viewed by the user 1220 and the θₓ, θ_{y}, θ_{z} angular coordinates may be indicative of which switches and their ports within the stack are being viewed by the user 1220. The image 1250 may correspond to a real-time FOV visible to the user 1220 via the AR device 1210.

The AR device 1210 may transmit the captured image 1250 of one or more objects or devices 1230 and the determined position data to the application server 1240. The application server 1240 can identify one or more objects or devices visible in the FOV of the user 1220 (e.g., the image 1250). In still more embodiments, the application server 1240 can identify the one or more objects or devices by transmitting a request to an object identification database. The request may comprise the position data of the AR device 1210. In still further embodiments, the application server 1240 can identify a Quick Response (QR) code, a barcode, or a serial number present on the one or more objects or devices in the image 1250 for identification purpose. In still further embodiments, the application server 1240 may receive object identification data from the AR device 1210. The AR device 1210 may use Radio Frequency Identification (RFID) tags, Bluetooth Low Energy (BLE) beacons or Near Field Communication (NFC) to obtain the object identification data from the one or more objects or devices visible in the FOV of the user 1220.

In still additional embodiments, the application server 1240 may identify corresponding controllers for each of the one or more objects visible in the FOV of the user 1220. In some more embodiments, the application server 1240 may transmit a status request to the corresponding controllers for the one or more objects 1230. In an example scenario, the image 1250, visible to the user 1220 in the AR device 1210, may be of a rack of switches at a specific location of a data center. The application server 1240 may identify one or more ports of the switches visible in the image 1250 based on the AR device 1210 position and orientation received from the AR device 1210. The application server 1240 may thus request corresponding controllers of the switches for status data of the one or more ports.

In still further embodiments, based on the received status data, the application server 1240 may generate overlay data for the received image 1250. The application server 1240 can transmit the overlay data to the AR device 1210 for presenting the status data to the user 1220 by way of an augmented image 1260 displayed in the AR device 1210. In certain embodiments, the overlay data may include or indicate one or more visual indicators 1270 that need to be superimposed on the image 1250. For example, as shown in FIG. 12, the augmented image 1260 presents one or more visual indicators 1270, for example, light emitting diode (LED) status indicators to the user 1220. The visual indicators 1270 may be superimposed at corresponding positions in the image 1250 based on the overlay data. For example, the visual indicators 1270 superimposed on the image 1250 may correspond to specific ports of the switches as identified by the application server 1240. The visual indicators 1270 may provide status information such as link established, ongoing data transfers, faults, selected speed, and other such operational statuses of the identified ports by means of different colors. For example, a visual indicator with red color may indicate that a corresponding port on which the visual indicator is superimposed has a fault in the link, while another visual indicator with green color may indicate that a corresponding port on which the visual indicator is superimposed has no fault in the link. Thus, the visual indicators 1270 when superimposed on the image 1250 (FOV of the user 1220) may enhance a perception of the user 1220 regarding the objects (e.g., ports of the switches, etc.).

In many further embodiments, the visual indicators 1270 may include one or more graphical elements that provide the same look and feel of LEDs. The visual indicators 1270 may be superimposed (e.g., partially or completely) on those pixel coordinates of the image 1250 where physical LEDs are or might have been present on the device 1230. The visual indicators 1270 may provide the same look and feel of physical LEDs, thus eliminating the need to keep the physical LEDs of the device 1230 in ON state or in fact eliminating the need to include physical LEDs in devices 1230.

Although a specific embodiment for an AR view in an AR device suitable for carrying out the various steps, processes, methods, and operations described herein is discussed with respect to FIG. 12, any of a variety of systems and/or processes may be utilized in accordance with embodiments of the disclosure. For example, in yet more embodiments, the one or more visual indicators 1270 presented in the augmented image 1260 on the AR device 1210 may comprise a visual mark configured to associate the at least one visual indicator with a corresponding object (such as a port of a switch) visible in the image 1250. The visual mark can be an arrow, a tail, or a pointer extending from a visual indicator to link the visual indicator with a corresponding device or an object of a device. Such visual marks may enable the user 1220 to link the corresponding visual indicator with its device. The elements depicted in FIG. 12 may also be interchangeable with other elements of FIGS. 1-11 and 13-22 as required to realize a particularly desired embodiment.

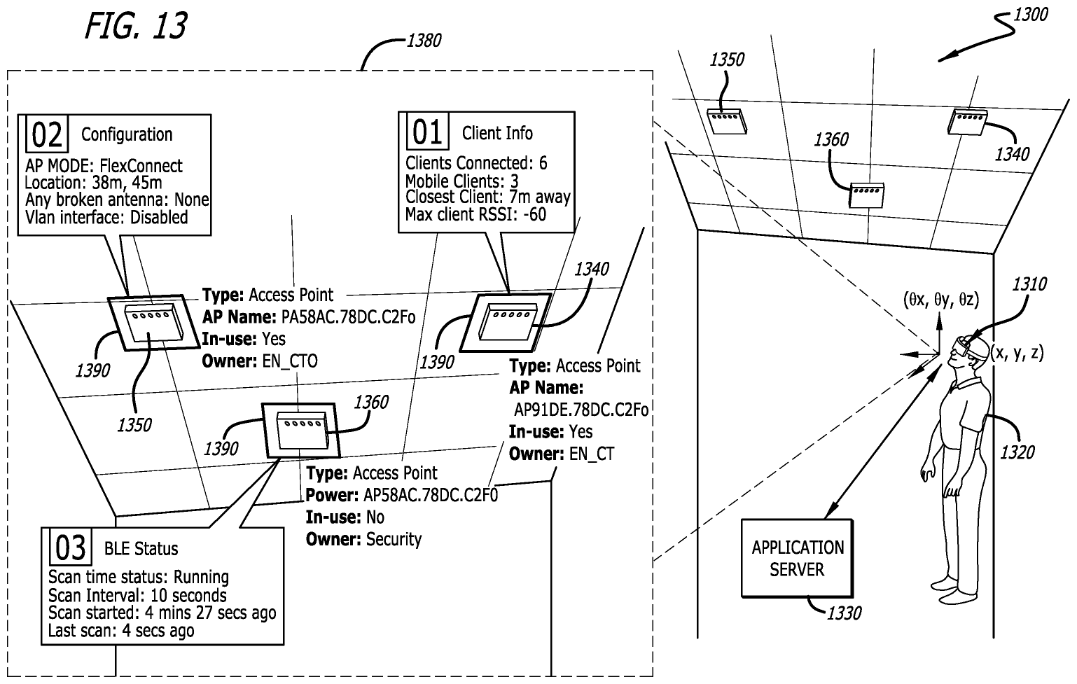

Referring to FIG. 13, a conceptual illustration 1300 of an AR device 1310 displaying status data in accordance with various embodiments of the disclosure is shown. The AR device 1310 can be worn by a user 1320 and may be communicatively coupled to an application server 1330.

In many embodiments, the AR device 1310 can be utilized by the user 1320 to get the status data of first through third ceiling mounted devices 1340, 1350, and 1360 (also referred to as first through third devices 1340, 1350, and 1360 with reference to FIG. 13) which may be difficult to physically access by the user 1320. The AR device 1310 can determine its position data and capture an image of the first through third devices 1340, 1350, and 1360. In a number of embodiments, the AR device 1310 can transmit the captured image and the position data to the application server 1330.

In numerous embodiments, the application server 1330 can identify the first through third devices 1340, 1350, and 1360 visible in the received image and retrieve relevant status data corresponding to each of the first through third devices 1340, 1350, and 1360. The application server 1330 may generate overlay data based on the corresponding status data of each of the first through third devices 1340, 1350, and 1360. The overlay data can be an augmented overlay that includes visual indicators for representing the status data of the first through third devices 1340, 1350, and 1360 or can facilitate generation of the augmented overlay for superimposition onto the image captured by the AR device 1310.

The application server 1330 can transmit the overlay data to the AR device 1310 to facilitate generation of an augmented image 1380. The augmented image 1380 may be generated by superimposing the augmented overlay on the image captured by the AR device 1310. In a variety of embodiments, the application server 1330 may retrieve different type of status data for each device of the first through third devices 1340, 1350, and 1360. For example, the embodiments depicted in the conceptual diagram 1300 may show a scenario where the AR device 1310 may display the augmented image 1380 showing three ceiling mounted APs 1340, 1350, and 1360. The augmented image 1380 may further show a bounding box 1390 around each of the ceiling mounted APs 1340, 1350, and 1360. The bounding box 1390 may indicate the one or more devices or objects identified by the application server 1330. The augmented image 1380 may further display augmented status information for each of the ceiling mounted APs 1340, 1350, and 1360. The augmented status information (e.g., a callout box for “01Client Info”) for the AP 1340 may indicate client statistics data, while the augmented status information (e.g., a callout box for “02 Configuration”) for the AP 1350 may indicate configuration data. For example, client statistics data for the AP 1340 may provide information regarding, but not limited to, the number of clients associated with the AP 1340, closest client distance, type of clients (fixed or mobile), RSSI of the associated clients, or the like. Likewise, the augmented status information (e.g., a callout box for “03 BLE Status”) for the AP 1360 may indicate Bluetooth Low Energy (BLE) status. For example, the BLE status for the AP 1360 can indicate scan timer status, scan interval, number of connected devices, power-saving mode, and other such information. In some embodiments, the augmented overlay may also include status data related to a type of network device, owner of the device, or similar information. In several more embodiments, the augmented status information may be presented via graphical elements, e.g., the callout boxes. In numerous embodiments, the graphical elements may also include visual marks configured to associate respective graphical element with a corresponding object. The visual mark can be an arrow, a tail, or a pointer extending from the graphical element to link the graphical element with the corresponding object. For example, in FIG. 13, visual marks can be the tails extending from the callout boxes.

In more embodiments, the type of status data to be presented in the augmented image 1380 can be a configurable feature. For example, the application server 1330 may receive a user input provided, for example, via the AR device 1310 by the user 1320 to configure the type of status data. When the client statistics data is to be evaluated, a user input indicating the client statistics data may be provided to the application server 1330. The application server 1330 may then retrieve the status data indicating the client statistics data for presenting to the user 1320 via the augmented image 1380.

In additional embodiments, the application server 1330 may transmit one or more control signals corresponding to the first through third devices 1340, 1350, and 1360 based on the status data. For example, for the first device 1340, the application server 1330 may transmit the control signal to switch to 5 GHz Wi-Fi band as all user devices connected to the first device 1340 are connected on the 5 GHz Wi-Fi band. The application server 1330 may also transmit a control signal to the first device 1340 for reducing its transmission power as one or more user devices connected to the first device 1340 are located at short distances. Similarly, the application server 1330 may transmit a second control signal to the second device 1350 to change the AP mode from FlexConnect to Local Mode or Bridge Mode. Cisco APs can operate in various modes such as in FlexConnect mode the AP can operate in a distributed architecture, providing local switching and authentication services at the network edge. FlexConnect mode is useful for remote sites having unstable Wide Area Network (WAN) links, as it avoids the need for all traffic to go through the centralized Wireless LAN Controller (WLC). In Local Mode, the AP operates as a lightweight device and requires connectivity to a Cisco Wireless LAN Controller (WLC) for configuration, management, and centralized control. Similarly, Bridge Mode is used to extend network connectivity to remote locations and allows the AP to operate as a wireless bridge, facilitating point-to-point or point-to-multipoint wireless connections between different network segments. In certain embodiments, the control signals may be generated based on a user input provided by the user 1320 via the AR device 1310, for example, after viewing the status data in the augmented image 1380.

Although a specific embodiment for the AR device 1310 displaying status data for carrying out the various steps, processes, methods, and operations described herein is discussed with respect to FIG. 13, any of a variety of systems and/or processes may be utilized in accordance with embodiments of the disclosure. For example, in further embodiments, the application server 1330 may transmit control signals to any of the first through third devices 1340, 1350, 1360 via the AR device 1310. For example, the application server 1330 may transmit the control signal to the third device 1360 via the AR device 1310 to switch to a power saving mode/sleep mode based on the determination that no client/user device is connected to the third device 1360. The elements depicted in FIG. 13 may also be interchangeable with other elements of FIGS. 1-12 and FIGS. 14-22 as required to realize a particularly desired embodiment.

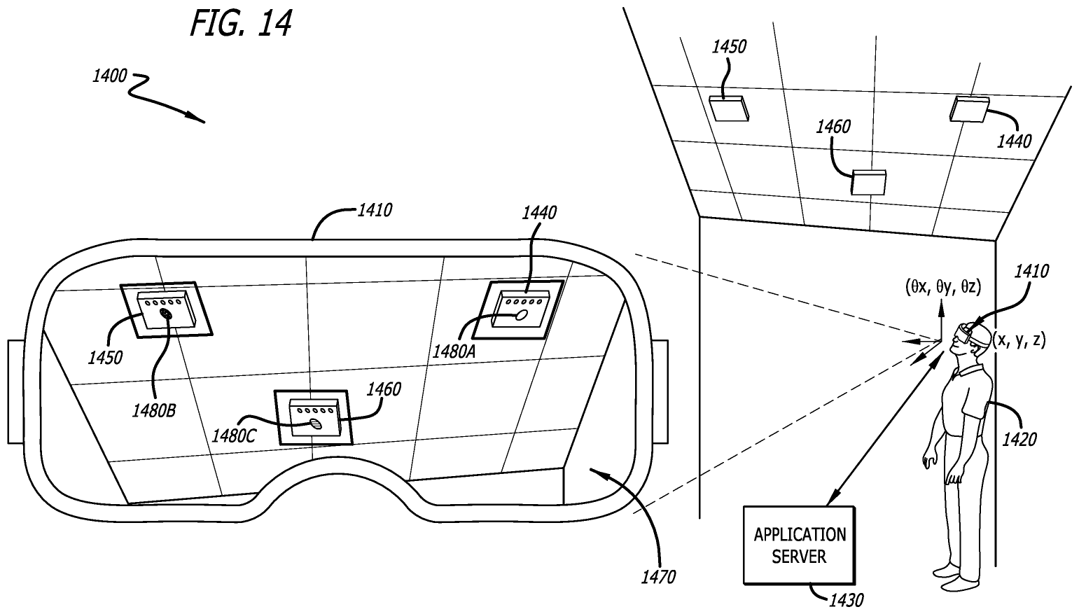

Referring to FIG. 14, a conceptual illustration 1400 of an AR device displaying visual indicators in accordance with various embodiments of the disclosure is shown. In many embodiments, the AR device 1410 can be utilized to inspect first through third ceiling mounted devices 1440, 1450, and 1460 (also referred to as first through third devices 1440, 1450, and 1460 with reference to FIG. 14) which may be difficult to physically access by a user 1420 wearing the AR device 1410. The AR device 1410 can be communicatively coupled to an application server 1430.

In a number of embodiments, the first through third devices 1440, 1450, and 1460 may not have any physical LEDs or similar visual status indicators present on them. The AR device 1410 can determine its position data and capture an image of the first through third devices 1440, 1450, and 1460. In a variety of embodiments, the AR device 1410 can transmit the image and the position data to the application server 1430. The application server 1430 can identify the first through third devices 1440, 1450, and 1460, and obtain or retrieve relevant status data corresponding to each of the first through third devices 1440, 1450, and 1460 from the corresponding controllers. In numerous embodiments, the status data may correspond to an operational status of the first through third devices 1440, 1450, and 1460. In some embodiments, the application server 1430 may translate the status data into one or more visual indicators. For example, status data indicating a fault in link status may be translated into a graphical element of a red colored LED. The application server 1430 may translate the retrieved status data into one or more visual indicators by accessing a mapping database. The mapping database may store different types of status data mapped to corresponding visual indicators.

In more embodiments, the application server 1430 can generate overlay data based on the corresponding status data of each of the first through third devices 1440, 1450, and 1460. The overlay data can include corresponding translated visual indicators for the status data of the first through third devices 1440, 1450, and 1460. In numerous embodiments, the overlay data may also comprise pixel coordinates for the visual indicators to indicate a position at which the visual indicators shall be superimposed on the image in the AR device 1410. The application server 1430 may transmit the overlay data to the AR device 1410 and the AR device 1410 may generate an augmented image 1470 based on the overlay data. In the augmented image 1470, the visual indicators corresponding to the status data of each of the first through third devices 1440, 1450, and 1460 may be, for example, at least partially superimposed on the first through third devices 1440, 1450, and 1460. For example, the visual indicators may represent one or more LED indicators 1480A, 1480B and 1480C to be superimposed at a position of each of the first through third devices 1440, 1450, and 1460 visible in the captured image. The one or more LED indicators may be of different colors to indicate different status for each of the first through third devices 1440, 1450, and 1460. For instance, the LED indicator 1480A superimposed on the first device 1440 in the augmented image 1470 may be of yellow color indicating a specific speed selected. Similarly, the LED indicator 1480B superimposed on the second device 1450 in the augmented image 1470 may be of red color indicating a fault in the network. In a similar manner, the LED indicator 1480C superimposed on the third device 1460 in the augmented image 1470 may be of green color indicating an established link. Similarly, the LED indicator superimposed on the one or more objects in the augmented image may be of blue color indicating an ongoing data transfer.

Although a specific embodiment for the AR device 1410 displaying visual indicators suitable for carrying out the various steps, processes, methods, and operations described herein is discussed with respect to FIG. 14, any of a variety of systems and/or processes may be utilized in accordance with embodiments of the disclosure. For example, the application server 1430 may intelligently translate the status data into visual indicators based on a context of the received status data for the first through third devices 1440, 1450, and 1460 and transmit the generated visual indicators to the AR device 1410 as augmented overlay for superimposing on the captured image. The elements depicted in FIG. 14 may also be interchangeable with other elements of FIGS. 1-13 and FIGS. 15-22 as required to realize a particularly desired embodiment.

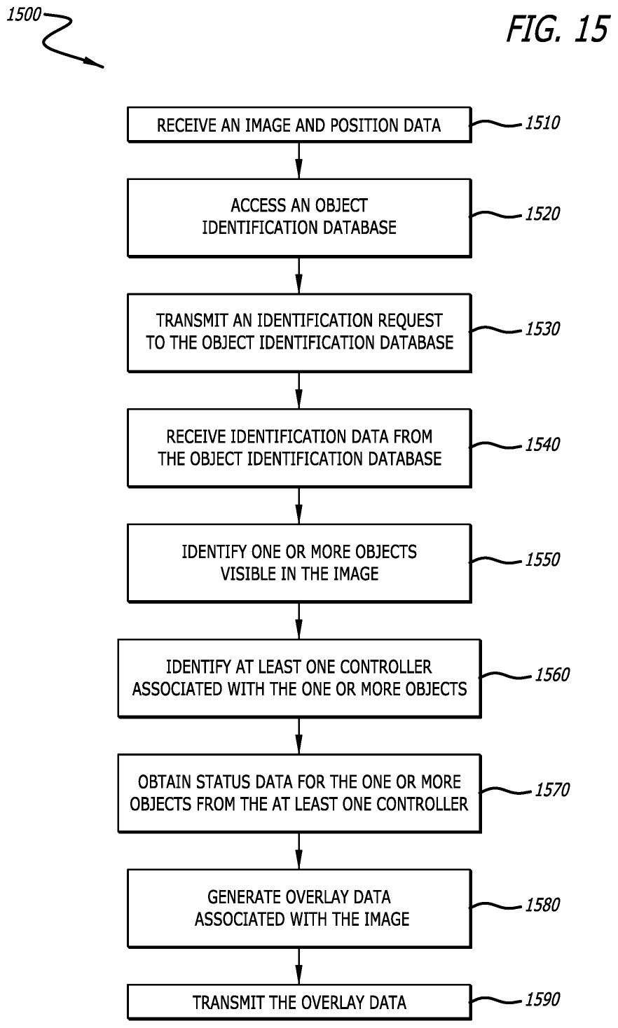

Referring to FIG. 15, a flowchart depicting a process 1500 for displaying status data on an AR device in accordance with various embodiments of the disclosure is shown. In many embodiments, the process 1500 can receive the image and position data (block 1510). In some embodiments, the process 1500 may be an AR device management process. In certain embodiments, the process 1500 can be implemented by an application server that is in communication with the AR device. Examples of the AR device can include, but are not limited to, smart glasses, AR glasses, AR headsets, AR goggles, or head mounted displays, etc. In more embodiments, the process 1500 may be implemented by various types of devices, such as but not limited to, a smartphone, a tablet, or a personal computer, etc. In some more embodiments, the devices may be equipped with a camera to capture the image or to capture videos, in real-time or near-real time. In numerous embodiments, the process 1500 may receive the image from an external source or an external device. In many further embodiments, the process 1500 can retrieve the image from an internal memory of the AR device or fetch the image from an external database. In still more embodiments, the image can be a frame in a video feed. In many additional embodiments, the image may depict one or more objects. Examples of the objects may include network devices, such as but not limited to, switches, routers, or gateways, etc. More examples of the objects can also include connections between the devices, such as but not limited to, wires, cables, or optical fibers, etc. Further examples of the objects may include equipment or appliances, such as but not limited to, light bulbs, displays (for example, televisions or monitors), ceiling mounted devices such as projectors or smoke detectors, air conditioning systems, HVACs, or Wi-Fi Access Points (APs), etc. In still more embodiments, the objects can be Radio Frequency Identification (RFID) tags, Near-Field Communication (NFC) tags, QR codes, Bluetooth Low Energy (BLE) beacons, or barcodes etc. Some more examples of the objects may include, but are not limited to, power supplies, wall plugs/outlets, generators, or batteries etc. In still yet further embodiments, the process 1500 may determine the AR device position data. In still yet additional embodiments, the device position data may include spatial data, including the position of the AR device and the orientation of the AR device. In several embodiments, for the position of the device, the device position data may include three-dimensional coordinates, viz. x, y, z coordinates of the AR device. In several more embodiments, for example, the x, y, z coordinates can indicate the position of the AR device in an indoor space, such as a room. In numerous embodiments, the x, y, z coordinates can indicate the position of the AR device in an outdoor space. In numerous additional embodiments, for the orientation of the device, the device position data may include three-dimensional angular coordinates, viz. θₓ, θ_{y}, θ_{z} angular coordinates of the AR device. In further additional embodiments, for example, the θₓ, θ_{y}, θ_{z} angular coordinates can indicate the orientation, for example, angles made by the AR device along x, y, z axes.

In various embodiments, the process 1500 can access an object identification database (block 1520). In a number of embodiments, the object identification database may include a mapping of the objects and their locations. In a variety of embodiments, the object identification database may include identifiers associated with the objects. The object identification database may retrieve object identifiers of the objects present in an area associated with the device position data and/or the object position data

In some embodiments, the process 1500 may transmit an identification request to the object identification database (block 1530). In more embodiments, the identification request may include the device position data and/or the object position data. For example, the identification request may include the spatial data and the orientation data of the AR device.

In additional embodiments, the process 1500 may receive the identification data from the object identification database (block 1540). The identification data may include information such as name assigned to the object, Internet Protocol (IP) address or Media Access Control (MAC) address associated with the switch, serial number, etc. The identification data may include information such as, but not limited to, object identifiers, types of objects, or controllers associated with the objects, etc.

In further embodiments, the process 1500 can identify one or more objects visible in the image (block 1550). In still more embodiments, the process 1500 may identify one or more objects visible in the image based on the object identifiers retrieved from the object identification database. For instance, the process 1500 may identify one or more rack of switches associated with the AR device position and orientation, and may identify at least one port associated with the one or more switches visible in the image.

In still further embodiments, the process 1500 can identify at least one controller associated with the one or more objects (block 1560). In still additional embodiments, the process 1500 may utilize an application server to determine the at least one controller based on the identification data associated with the one or more objects. For example, in some more embodiments, if the object is a switch or a database, the application server can determine a server or cloud server that is connected to the switch or the database. In certain embodiments, controllers may be connected to the application server by way of wired or wireless networks.

In some more embodiments, the process 1500 may obtain status data for the one or more objects from the at least one controller (block 1570). In certain embodiments, the application server may transmit a status request to the at least one controller to obtain the status data of the identified one or more objects visible in the image. For instance, the status request may include an identifier (for example, Internet Protocol (IP) address or Media Access Control (MAC) address) associated with the one or more objects, name of the objects, type of the objects, or other information indicated by the identification data corresponding to the one or more objects.

In yet more embodiments, the process 1500 may generate overlay data associated with the image (block 1580). In still yet more embodiments, the overlay data may be generated by the application server based on the obtained status data. In many further embodiments, the overlay data may correspond to an augmented overlay configured to be superimposed on the received image to present the status data. For instance, the overlay data may include status data corresponding to port characteristics, port statistics data, switch box status, AP configuration information, etc. The overlay data may include one or more graphical elements for presenting the status data. In many additional embodiments, the overlay data may be configured to facilitate a generation of the augmented overlay to be superimposed on the received image. For example, the overlay data may include pixel coordinates indicating positions in the image where specific status data is to be superimposed.

In still yet further embodiments, the process 1500 may transmit the overlay data (block 1590). In still yet additional embodiments, the process 1500 may be executed by the application server to transmit the overlay data to the AR device. In several embodiments, the application server may transmit the overlay data to various types of computing devices, such as but not limited to, a smartphone, a tablet, or a personal computer, etc. In several more embodiments, the overlay data may be used by the AR device to generate an augmented image by superimposing the augmented overlay on the captured image. The augmented overlay can be included in the overlay data or can be generated based on the overlay data.

Although a specific embodiment for displaying status data on an AR device suitable for carrying out the various steps, processes, methods, and operations described herein is discussed with respect to FIG. 15, any of a variety of systems and/or processes may be utilized in accordance with embodiments of the disclosure. For example, the application server of the process 1500 may also identify the one or more objects based on scanning or processing of QR codes, BLE beacons, barcodes, RFID tags, or NFC tags associated with the one or more objects. The elements depicted in FIG. 15 may also be interchangeable with other elements of FIGS. 1-14 and 16-22 as required to realize a particularly desired embodiment.

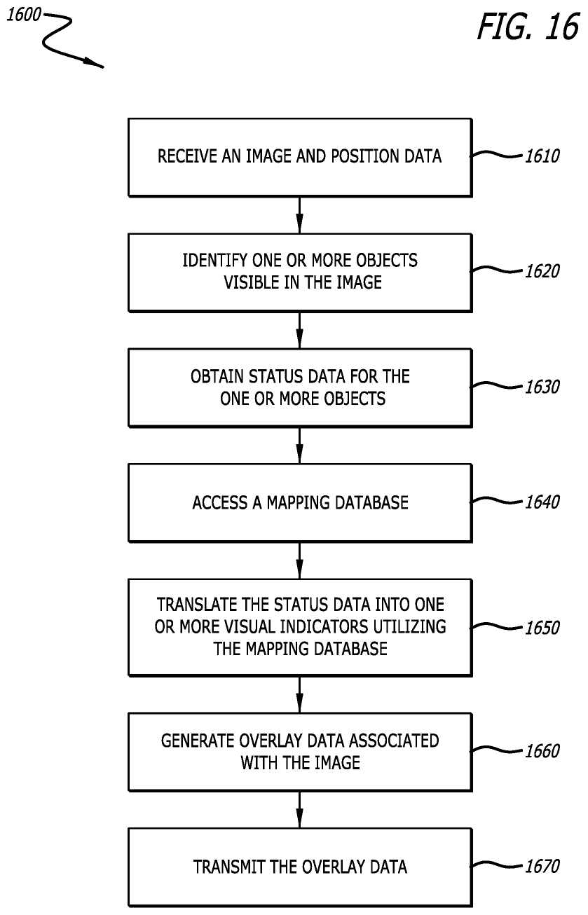

Referring to FIG. 16, a flowchart depicting a process 1600 for translation of status data into visual indicators in accordance with various embodiments of the disclosure is shown. In many embodiments, the process 1600 can receive an image and position data (block 1610). In a number of embodiments, the process 1600 may be implemented by an application server communicatively coupled with an AR device. In a variety of embodiments, the AR device may be equipped with a camera to capture the image or to capture videos, in real-time or near-real time. The image or video may be of one or more objects. For example, the objects may include network devices, such as but not limited to, switches, routers, gateways, access points, projectors, etc. In some embodiments, the device position data may include spatial data, including the position of the AR device and the orientation of the AR device. The application server may receive the image and the position data from the AR device.

In more embodiments, the process 1600 can identify one or more objects visible in the image (block 1620). In additional embodiments, the application server can use an object identification database to identify the one or more objects. The one or more objects may be identified based on identification data such as name assigned to the object, Internet Protocol (IP) address or Media Access Control (MAC) address associated with the switch, serial number, etc.

In additional embodiments, the process 1600 can obtain status data for the one or more objects (block 1630). In further embodiments, the application server may retrieve the status data associated with the one or more objects identified in the image. In still more embodiments, the status data may be retrieved from at least one controller associated with the one or more objects.

In still further embodiments, the process 1600 can access a mapping database (block 1640). In still additional embodiments, the process 1600 may access the mapping database via the application server. The mapping database may store mappings for each status data and corresponding visual indicator. Visual indicator may be a graphical element (for example, a callout table, a callout box, an LED, or the like) for presenting status data. For example, the mapping database may store a graphical element in the form of a callout table for displaying various port characteristics corresponding to the identification of the one or more objects as a switch port. Similarly, the mapping database may store a graphical element in the form of a callout box for displaying configuration status corresponding to the identification of the one or more objects as an access point. In some more embodiments, the process 1600 may configure the type of graphical element to be displayed for the one or more objects based on a type of status data required.

In certain embodiments, the process 1600 may translate the status data into one or more visual indicators utilizing the mapping database (block 1650). In yet more embodiments, the process 1600 may translate the status data into one or more LED indicators. For example, the application server may obtain the status data indicating a fault in the link of an AP visible in the image. The application server may search for the faulty link status in the mapping database and identify a visual indicator mapped to the faulty link status in the mapping database. In other words, the status data is translated in response to the identification of the visual indicators in the mapping database.

In still yet more embodiments, the process 1600 may generate overlay data associated with the image (block 1660). In many further embodiments, the overlay data may be an augmented overlay including one or more visual indicators obtained from the mapping database by translating the status data. In the augmented overlay, the visual indicators may be mapped to precise coordinates of the one or more objects visible in the image. In many additional embodiments, the overlay data may facilitate generation of an augmented overlay for the image. In such embodiments, the overlay data may include precise pixel coordinates of the image at which the one or more visual indicators are to be superimposed.

In still yet further embodiments, the process 1600 may transmit the overlay data (block 1670). In still yet additional embodiments, the application server may transmit the overlay data to the AR device. In several embodiments where the overlay data corresponds to the augmented overlay, the AR device may superimpose the overlay data on the image to generate an augmented image. In many embodiments where the overlay data may be configured to facilitate the generation of an augmented overlay, the AR device may generate the augmented overlay based on the overlay data. For example, the application server may transmit the overlay data indicating that a visual indicator of a red LED indicator is to be superimposed at the center of an AP visible in the image. Thus, the AR device may generate an augmented overlay in which the red LED indicator is precisely positioned at pixel coordinates that correspond to the center of the AP visible in the image. The AR device may superimpose the augmented overlay on the image to generate the augmented image.

Although a specific embodiment for translation of status data into visual indicator suitable for carrying out the various steps, processes, methods, and operations described herein is discussed with respect to FIG. 16, any of a variety of systems and/or processes may be utilized in accordance with embodiments of the disclosure. For example, in several more embodiments, the application server may generate and transmit an augmented image having one or more visual indicators superimposed on the image to the AR device. The elements depicted in FIG. 16 may also be interchangeable with other elements of FIGS. 1-15 and 17-22 as required to realize a particularly desired embodiment.

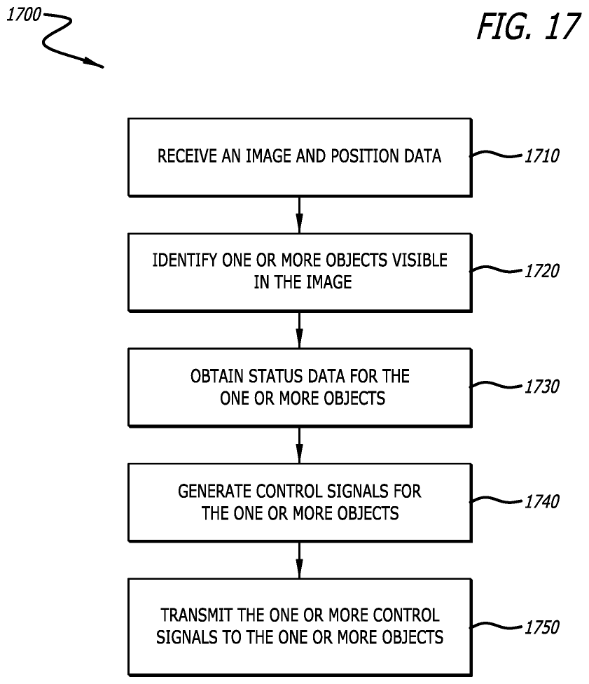

Referring to FIG. 17, a flowchart depicting a process 1700 for generating a control signal based on status data in accordance with various embodiments of the disclosure is shown. In many embodiments, the process 1700 may receive an image and position data (block 1710). In a number of embodiments, the process 1700 may be implemented by an application server communicatively coupled to an AR device. In a variety of embodiments, the AR device may be equipped with a camera to capture the image or to capture videos of one or more objects such as switches, routers, gateways, access points, etc. In some embodiments, the device position data may include spatial data, including the position of the AR device and the orientation of the AR device.

In more embodiments, the process 1700 can identify one or more objects visible in the image (block 1720). In additional embodiments, the process 1700 may use the application server to access an object identification database to identify the one or more objects. The one or more objects may be identified based on identification data such as name assigned to the object, Internet Protocol (IP) address or Media Access Control (MAC) address associated with the switch, serial number, etc.

In further embodiments, the process 1700 may obtain status data for the one or more objects (block 1730). In still more embodiments, the process 1700 may use the application server to obtain the status data associated with the one or more objects identified in the image. In still further embodiments, the status data may be obtained from at least one controller associated with the one or more objects. In still additional embodiments, the status data may correspond to port characteristics, communication port statistics data, client statistics data, box status data, uptime information, configuration information, version information, link status, power consumption data, operational status data, or other such status information of network devices. In numerous embodiments, the status data may be indicative of power consumption data of the one or more objects. For example, the status data may indicate the amount of power consumed by a rack of switch in a given month. In various other embodiments, the status data may also include information regarding power management features such as power saving modes, port scheduling, and usage of intelligent power management algorithms. In still other embodiments, the status data may include hardware, software, or firmware version information associated with the one or more objects. The status data may indicate unique version numbers or identifiers assigned to different releases or revisions of the hardware, software, or firmware associated with the one or more objects. Version information may help in tracking changes, updates, or improvements made to the hardware, software, or firmware over time, thus facilitating management, troubleshooting, and compatibility testing. In numerous additional embodiments, the status data may include port statistics data that can include metrics such as number of incoming and outgoing packets, speed, status, duplex mode of the connection, number of packets discarded due to congestion, buffer overflows, or other reasons, error rates, number of broadcast and multicast packets received and transmitted on the port, and other such network related information. In further additional embodiments, the status data can include port utilization data that indicates the percentage of time a port is actively transmitting or receiving data relative to its maximum capacity.

In some more embodiments, the process 1700 may generate control signals for the one or more objects (block 1740). In certain embodiments, the application server may generate the controls signals based on the status data for the one or more objects. In yet more embodiments, the control signals may be generated to indicate a change in the operational states (such as power saving modes, for example) of the one or more objects, switching the one or more objects ON/OFF, etc. For example, the application server may generate a control signal to power OFF a switch.

In still yet more embodiments, the process 1700 may transmit the one or more control signals to the one or more objects (block 1750). In many further embodiments, the application server may transmit the control signals to the one or more objects to facilitate changing of the operational states of the one or more objects. In many additional embodiments, the application server can transmit the control signal to the controllers, or to any other devices associated with the one or more objects, to relay the control signal to the one or more objects.

Although a specific embodiment for generating a control signal based on status data suitable for carrying out the various steps, processes, methods, and operations described herein is discussed with respect to FIG. 17, any of a variety of systems and/or processes may be utilized in accordance with embodiments of the disclosure. For example, in still yet further embodiments, the process 1700 may authenticate a user based on received biometric data of the user to provide different control levels to the user based on a determination of the level of administrative access assigned to the user. In numerous embodiments, the process 1700 may use an iris scanner, present on the one or more objects, to validate the user. In various embodiments, the process 1700 may establish a connection with the controller associated with the one or more objects without the user typing in any information. The elements depicted in FIG. 17 may also be interchangeable with other elements of FIGS. 1-16 and 18-22 as required to realize a particularly desired embodiment.

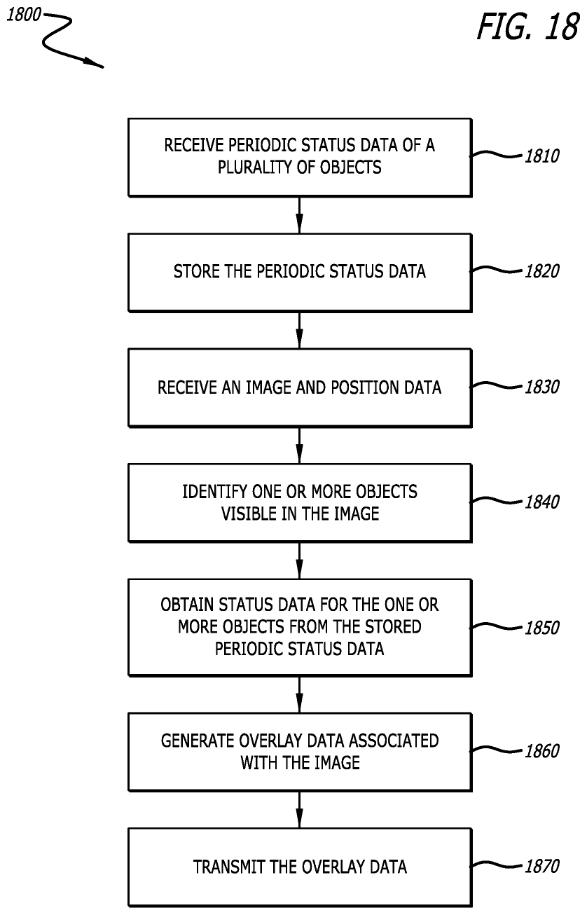

Referring to FIG. 18, a flowchart depicting a process 1800 for receiving periodic status of the one or more objects in accordance with various embodiments of the disclosure is shown. In many embodiments, the process 1800 can receive periodic status data of a plurality of objects (1810). In a number of embodiments, the process 1800 can receive the periodic status data of the plurality of objects from corresponding controllers. For example, the controllers of the plurality of objects can transmit the status data of the plurality of objects to an application server at a regular time period. For example, a controller may transmit the status of one or more ports of a switch to the application server every 15 seconds. In more embodiments, the controllers may be a part of the plurality of objects. For example, the controller may be embedded in a network switch and provide functionality of routing, VLAN management, etc. In additional embodiments, the controller may be a centralized controller that serves as the central intelligence for managing and controlling multiple switches or objects within a network.

In a variety of embodiments, the process 1800 can store the periodic status data (block 1820). In some embodiments, the application server, implementing the process 1800, may store the periodic status data associated with the plurality of objects. The application server may store the periodic status data in a database. The application server may update the database upon receiving the periodic status data.

In further embodiments, the process 1800 can receive an image and position data (block 1830). In still more embodiments, the process 1800 may be implemented by the application server communicatively coupled to an AR device. In still further embodiments, the AR device may be equipped with a camera to capture the image or to capture videos of one or more objects. For example, the objects may include network devices, such as but not limited to, switches, routers, gateways, access points, projectors, conference room resources, digital lighting/equipment, etc. In still additional embodiments, the device position data may include spatial data, including the position of the AR device and the orientation of the AR device. The application server may receive the image and position data from the AR device.

In some more embodiments, the process 1800 can identify one or more objects visible in the image (block 1840). In certain embodiments, the process 1800 may use the application server to access an object identification database to identify the one or more objects. The one or more objects may be identified based on identification data such as name assigned to the object, Internet Protocol (IP) address or Media Access Control (MAC) address associated with the switch, serial number, etc. In yet more embodiments, the application server may identify the objects by scanning or processing QR codes, BLE beacons, barcodes, RFID tags, or NFC tags associated with the one or more objects.

In still yet more embodiments, the process 1800 can obtain status data for the one or more objects from the stored periodic status data (block 1850). In many further embodiments, the process 1800 may cause the application server to retrieve the status data of the one or more objects visible in the image from the stored periodic data. In many additional embodiments, the application server may identify one or more controllers associated with the one or more objects and retrieve the stored periodic status data that correspond to the one or more objects.

In still yet further embodiments, the process 1800 may generate overlay data associated with the image (1860). In still yet additional embodiments, the application server may generate the overlay data based on the retrieved status data. In numerous additional embodiments, the overlay data may be an augmented overlay including one or more visual indicators (e.g., graphical elements) that indicate characteristic details of the one or more objects, port characteristics data, operational status data of the one or more objects, or the like. For example, the operational status data may include link status data, fault status, speed status, data transfer status, or the like for the one or more objects such as an AP. In the augmented overlay, the visual indicators may be mapped to precise coordinates of the one or more objects visible in the image. In further additional embodiments, the overlay data may facilitate generation of an augmented overlay for the image. In such embodiments, the overlay data may include precise pixel coordinates of the image at which the one or more visual indicators are to be superimposed.

In several embodiments, the process 1800 can transmit the overlay data (block 1870). In several more embodiments, the process 1800 may cause the application server to transmit the overlay data to the AR device. In numerous embodiments, the AR device may superimpose the overlay data on the image being displayed in the AR device to generate an augmented image. In certain embodiments, the AR device may generate an augmented overlay based on the overlay data and superimpose the augmented overlay on the image being displayed in the AR device to generate the augmented image.

Although a specific embodiment for receiving periodic status of the one or more objects suitable for carrying out the various steps, processes, methods, and operations described herein is discussed with respect to FIG. 18, any of a variety of systems and/or processes may be utilized in accordance with embodiments of the disclosure. For example, in numerous additional embodiments, the application server may transmit a graphical element to be at least partially superimposed on at least one or more objects visible in the image. The elements depicted in FIG. 18 may also be interchangeable with other elements of FIGS. 1-17 and 19-22 as required to realize a particularly desired embodiment.

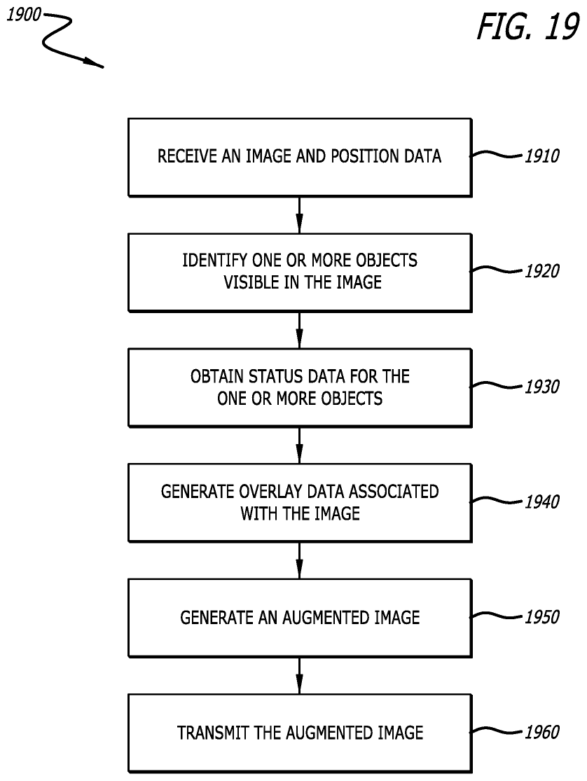

Referring to FIG. 19, a flowchart depicting a process 1900 for generating an augmented image in accordance with various embodiments of the disclosure is shown. In many embodiments, the process 1900 can receive an image and position data (block 1910). In a number of embodiments, the process 1900 may be implemented by an application server communicatively coupled with an AR device. In a variety of embodiments, the AR device may be equipped with a camera to capture the image or to capture videos of one or more objects such as switches, routers, gateways, access points, etc. In some embodiments, the device position data may include spatial data, including the position of the AR device and the orientation of the AR device. The application server may receive the image of the one or more objects and the position data from the AR device.

In more embodiments, the process 1900 may identify the one or more objects visible in the image (block 1920). In additional embodiments, the process 1900 may identify the one or more objects visible in the image captured by the AR device based on object identifiers retrieved from an object identification database. For example, the process 1900 may identify one or more rack of switches associated with the AR device position and orientation and may identify at least one port associated with the one or more switches visible in the image.

In further embodiments, the process 1900 may obtain status data for the one or more objects (block 1930). In still more embodiments, the application server may obtain the status data for the one or more objects from the corresponding one or more controllers. In still further embodiments, the application server can request the status data in near real time or can retrieve the stored periodic status data of the one or more objects.

In still additional embodiments, the process 1900 may generate overlay data associated with the image (block 1940). In some more embodiments, the overlay data may be generated by the application server based on the obtained status data for the one or more objects. In certain embodiments, the overlay data may be an augmented overlay including one or more visual indicators that indicate the obtained status data. In the augmented overlay, the visual indicators may be mapped to precise coordinates of the one or more objects visible in the image.

In yet more embodiments, the process 1900 may generate an augmented image (block 1950). In still yet more embodiments, the application server may generate the augmented image by superimposing the overlay data on the image. When the overlay data is superimposed on the image, the visual indicators may also be superimposed at the precise coordinates of the one or more objects visible in the image.

In many additional embodiments, the process 1900 may transmit the augmented image (block 1960). In still yet further embodiments, the application server may transmit the augmented image to be displayed on the AR device. In still yet additional embodiments, the application server may transmit the augmented image to a smartphone, a tablet, a personal computer, or other such display devices. The augmented image may present the one or more objects and the status data of the one or more objects. The status data of the one or more objects may be presented in the form of the one or more visual indicators (e.g., graphical elements).

Although a specific embodiment for generating an augmented image suitable for carrying out the various steps, processes, methods, and operations described herein is discussed with respect to FIG. 19, any of a variety of systems and/or processes may be utilized in accordance with embodiments of the disclosure. For example, in several embodiments, the overlay data may be transmitted to the AR device for generating the augmented image at the AR device. The elements depicted in FIG. 19 may also be interchangeable with other elements of FIGS. 1-18 and 20-22 as required to realize a particularly desired embodiment.

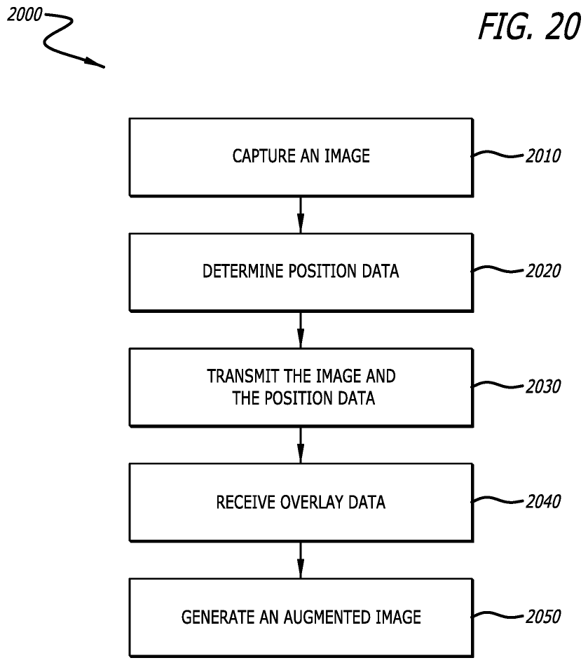

Referring to FIG. 20, a flowchart depicting a process 2000 for an AR device generating an augmented image in accordance with various embodiments of the disclosure is shown. In many embodiments, the process 2000 may capture an image (block 2010). In a number of embodiments, the process 2000 may be implemented by the AR device that is equipped with a camera to capture the image of one or more objects in real-time or near real-time. In a variety of embodiments, the one or more objects may include network devices, such as but not limited to, switches, routers, or gateways, etc.

In some embodiments, the process 2000 may determine position data (block 2020). In more embodiments, the process 2000 may determine position data of the AR device. In additional embodiments, the position data may include spatial data, including the position of the AR device and the orientation of the AR device. In further embodiments, the device position data may include three-dimensional coordinates, viz. x, y, z coordinates of the AR device. In still more embodiments, the device position data may further include three-dimensional angular coordinates, viz. θₓ, θ_{y}, θ_{z} angular coordinates of the AR device.

In still further embodiments, the process 2000 may transmit the image and the position data (block 2030). In still additional embodiments, the AR device may transmit the image depicting the one or more objects and the position data to an application server. In some more embodiments, the application server may identify the one or more objects visible in the image and identify their corresponding controllers. In certain embodiments, the application server may request status data for the one or more objects from the corresponding controllers. In yet more embodiments, the application server may generate overlay data based on the status data for the one or more objects.

In still yet more embodiments, the process 2000 may receive the overlay data (block 2040). In many further embodiments, the AR device may receive the overlay data comprising an augmented overlay configured to be superimposed on the image. In many additional embodiments, the overlay data may include visual indicators and corresponding pixel coordinates based on which an augmented overlay can be generated for superimposing on the image.

In still yet additional embodiments, the process 2000 may generate an augmented image (block 2050). In several embodiments, the AR device may superimpose the augmented overlay on the image to generate the augmented image. In several more embodiments, the augmented image may include graphical elements at least partially superimposed on the one or more corresponding objects to display the status data of the one or more objects. In certain embodiments, the visual indicators may include visual marks configured to associate respective visual indicator with a corresponding object visible in the image. The visual mark can be an arrow, a tail, or a pointer extending from the visual indicator to link the visual indicator with the corresponding device or the object visible in the image.

Although a specific embodiment for an AR device generating augmented image suitable for carrying out the various steps, processes, methods, and operations described herein is discussed with respect to FIG. 20, any of a variety of systems and/or processes may be utilized in accordance with embodiments of the disclosure. For example, in numerous embodiments, the AR device may provide options to a user to view a specific type of the status data as a visual indicator. The elements depicted in FIG. 20 may also be interchangeable with other elements of FIGS. 1-19 and 21-22 as required to realize a particularly desired embodiment.

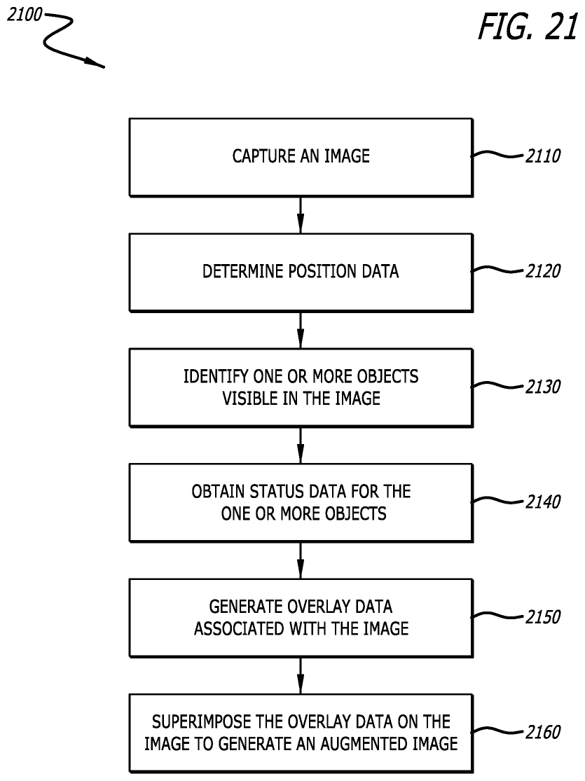

Referring to FIG. 21, a flowchart depicting a process 2100 for an AR device generating an augmented image in accordance with various embodiments of the disclosure is shown. In many embodiments, the process 2100 can capture an image (block 2110). In a number of embodiments, the process 2100 may be implemented by the AR device that is equipped with a camera to capture the image of one or more objects, in real-time or near real-time.

In a variety of embodiments, the process 2100 can determine position data (block 2120). In some embodiments, the process 2100 may determine position data of the AR device. In more embodiments, the position data may include spatial data, including the position of the AR device and the orientation of the AR device. In additional embodiments, for the position of the device, the device position data may include three-dimensional coordinates, viz. x, y, z coordinates of the AR device. In further embodiments, for the orientation of the device, the device position data may include three-dimensional angular coordinates, viz. θₓ, θ_{y}, θ_{z} angular coordinates of the AR device.

In still more embodiments, the process 2100 may identify one or more objects visible in the image (block 2130). In still further embodiments, the AR device may identify one or more objects visible in the image based on object identifiers retrieved from an object identification database. The one or more objects may be identified based on identification data such as name assigned to the object, Internet Protocol (IP) address or Media Access Control (MAC) address associated with the switch, serial number, etc. For example, the process 2100 may identify one or more rack of switches associated with the AR device position and orientation and may identify at least one port associated with the one or more switches visible in the image.

In still additional embodiments, the process 2100 may obtain status data for the one or more objects (block 2140). In some more embodiments, the AR device may request the status data for the one or more objects visible in the image from at least one controller. For example, the status request may include an identifier (for example, Internet Protocol (IP) address or Media Access Control (MAC) address) associated with the one or more objects, name of the objects, type of the objects, or other information indicated by the identification data corresponding to the one or more objects. In some more embodiments, the AR device may receive the status data from the at least one controller associated with the one or more objects.

In certain embodiments, the process 2100 may generate overlay data associated with the image (block 2150). In yet more embodiments, the AR device may generate overlay data based on the status data of the one or more objects. In many additional embodiments, the overlay data may be an augmented overlay including one or more visual indicators mapped to precise coordinates of the one or more objects visible in the image.

In many further embodiments, the process 2100 may superimpose the overlay data on the image to generate an augmented image (block 2160). In many additional embodiments, the AR device may superimpose the overlay data on the image to generate an augmented image. In several embodiments, the AR device may superimpose the one or more visual indicators on the image to generate the augmented image. For example, when the overlay data includes one or more graphical elements (e.g., visual indicators) depicting the status data of the one or more objects, the AR device may superimpose the graphical elements on the image. The generated augmented image may be displayed on the AR display to present the status data of the one or more objects to the user.

Although a specific embodiment for an AR device generating an augmented image suitable for carrying out the various steps, processes, methods, and operations described herein is discussed with respect to FIG. 21, any of a variety of systems and/or processes may be utilized in accordance with embodiments of the disclosure. For example, in many further embodiments, the AR device may identify the one or more objects by scanning or processing QR codes, BLE beacons, barcodes, RFID tags, or NFC tags associated with the one or more objects. The elements depicted in FIG. 21 may also be interchangeable with other elements of FIGS. 1-20 and 22 as required to realize a particularly desired embodiment.

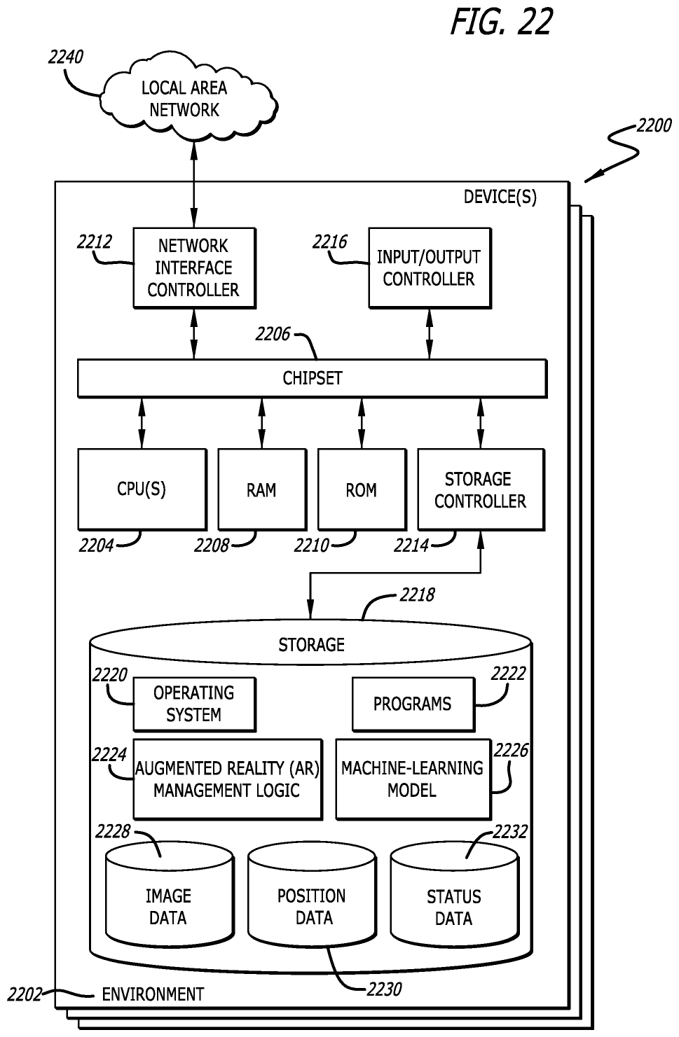

Referring to FIG. 22, a conceptual block diagram of a device 2200 suitable for configuration with an augmented reality (AR) logic in accordance with various embodiments of the disclosure is shown. The embodiment of the conceptual block diagram depicted in FIG. 22 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 22 can also illustrate an access point, a switch, or a router in accordance with various embodiments of the disclosure. The device 2200 may, in many non-limiting examples, correspond to physical devices or to virtual resources described herein.

In many embodiments, the device 2200 may include an environment 2202 such as a baseboard or “motherboard,” in physical embodiments that can be configured as a printed circuit board with a multitude of components or devices connected by way of a system bus or other electrical communication paths. Conceptually, in virtualized embodiments, the environment 2202 may be a virtual environment that encompasses and executes the remaining components and resources of the device 2200. In more embodiments, one or more processors 2204, such as, but not limited to, central processing units (“CPUs”) can be configured to operate in conjunction with a chipset 2206. The processor(s) 2204 can be standard programmable CPUs that perform arithmetic and logical operations necessary for the operation of the device 2200.

In a number of embodiments, the processor(s) 2204 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 2206 may provide an interface between the processor(s) 2204 and the remainder of the components and devices within the environment 2202. The chipset 2206 can provide an interface to a random-access memory (“RAM”) 2208, which can be used as the main memory in the device 2200 in some embodiments. The chipset 2206 can further be configured to provide an interface to a computer-readable storage medium such as a read-only memory (“ROM”) 2210 or non-volatile RAM (“NVRAM”) for storing basic routines that can help with various tasks such as, but not limited to, starting up the device 2200 and/or transferring information between the various components and devices. The ROM 2210 or NVRAM can also store other application components necessary for the operation of the device 2200 in accordance with various embodiments described herein.

Additional embodiments of the device 2200 can be configured to operate in a networked environment using logical connections to remote computing devices and computer systems through a network, such as the network 2240. The chipset 2206 can include functionality for providing network connectivity through a network interface card (“NIC”) 2212, which may comprise a gigabit Ethernet adapter or similar component. The NIC 2212 can be capable of connecting the device 2200 to other devices over the network 2240. It is contemplated that multiple NICs 2212 may be present in the device 2200, connecting the device to other types of networks and remote systems.

In further embodiments, the device 2200 can be connected to a storage 2218 that provides non-volatile storage for data accessible by the device 2200. The storage 2218 can, for instance, store an operating system 2220, applications 2222, image data 2228, device position data 2230, and status data 2232 which are described in greater detail below. The storage 2218 can be connected to the environment 2202 through a storage controller 2214 connected to the chipset 2206. In certain embodiments, the storage 2218 can consist of one or more physical storage units. The storage controller 2214 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The image data 2228 can include the images obtained by the camera coupled with the device 2200. The image data 2228 can also include the augmented images generated by the device 2200. The device position data 2230 may store the position and orientation of the device 2200. The status data 2232 can store the status data associated with the objects in the image. The status data 2232 can be received by the device 2200 from the controllers associated with the objects.

The device 2200 can store data within the storage 2218 by transforming the physical state of the physical storage units to reflect the information being stored. The specific transformation of physical state can depend on various factors. Examples of such factors can include, but are not limited to, the technology used to implement the physical storage units, whether the storage 2218 is characterized as primary or secondary storage, and the like.

In many more embodiments, the device 2200 can store information within the storage 2218 by issuing instructions through the storage controller 2214 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 2200 can further read or access information from the storage 2218 by detecting the physical states or characteristics of one or more particular locations within the physical storage units.

In addition to the storage 2218 described above, the device 2200 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 2200. In some examples, the operations performed by a cloud computing network, and or any components included therein, may be supported by one or more devices similar to the device 2200. Stated otherwise, some or all of the operations performed by the cloud computing network, and or any components included therein, may be performed by one or more devices 2200 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 2218 can store an operating system 2220 utilized to control the operation of the device 2200. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 2218 can store other system or application programs and data utilized by the device 2200.

In many additional embodiments, the storage 2218 or other computer-readable storage media is encoded with computer-executable instructions which, when loaded into the device 2200, may transform it from a general-purpose computing system into a special-purpose computer capable of implementing the embodiments described herein. These computer-executable instructions may be stored as application 2222 and transform the device 2200 by specifying how the processor(s) 2204 can transition between states, as described above. In some embodiments, the device 2200 has access to computer-readable storage media storing computer-executable instructions which, when executed by the device 2200, perform the various processes described above with regard to FIGS. 1-21. In certain embodiments, the device 2200 can also include computer-readable storage media having instructions stored thereupon for performing any of the other computer-implemented operations described herein.

In many further embodiments, the device 2200 may include an augmented reality management logic 2224. The augmented reality management logic 2224 can be configured to perform one or more of the various steps, processes, operations, and/or other methods that are described above. Often, the augmented reality management logic 2224 can be a set of instructions stored within a non-volatile memory that, when executed by the processor(s)/controller(s) 2204 can carry out these steps, etc. In some embodiments, the augmented reality management logic 2224 may be a client application that resides on a network-connected device, such as, but not limited to, a server, switch, personal or mobile computing device in a single or distributed arrangement. The augmented reality management logic 2224 can generate overlay data and augmented images based on the captured images, the status data and the access data.

In still further embodiments, the device 2200 can also include one or more input/output controllers 2216 for receiving and processing input from a number of input devices, such as a keyboard, a mouse, a touchpad, a touch screen, an electronic stylus, or other type of input device. Similarly, an input/output controller 2216 can be configured to provide output to a display, such as a computer monitor, a flat panel display, a digital projector, a printer, or other type of output device. Those skilled in the art will recognize that the device 2200 might not include all of the components shown in FIG. 22 and can include other components that are not explicitly shown in FIG. 22 or might utilize an architecture completely different than that shown in FIG. 22.

As described above, the device 2200 may support a virtualization layer, such as one or more virtual resources executing on the device 2200. In some examples, the virtualization layer may be supported by a hypervisor that provides one or more virtual machines running on the device 2200 to perform functions described herein. The virtualization layer may generally support a virtual resource that performs at least a portion of the techniques described herein.

Finally, in numerous additional embodiments, data may be processed into a format usable by a machine-learning model 2226 (e.g., feature vectors), and or other pre-processing techniques. The machine-learning (“ML”) model 2226 may be any type of ML model, such as supervised models, reinforcement models, and/or unsupervised models. The ML model 2226 may include one or more of linear regression models, logistic regression models, decision trees, Naïve Bayes models, neural networks, k-means cluster models, random forest models, and/or other types of ML models 2226.

The ML model(s) 2226 can be configured to generate inferences to make predictions or draw conclusions from data. An inference can be considered the output of a process of applying a model to new data. This can occur by learning from at least the image data 2228, the device position data 2230, and the status data 2232 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 2226 may be generated by human/administrator verifications or may compare predicted outcomes with actual outcomes.

Although a specific embodiment for the device 2200 suitable for configuration with the augmented reality management logic 2224 for carrying out the various steps, processes, methods, and operations described herein is discussed with respect to FIG. 22, any of a variety of systems and/or processes may be utilized in accordance with embodiments of the disclosure. For example, the device 2200 may be in a virtual environment such as a cloud-based network administration suite, or it may be distributed across a variety of network devices or switches. The elements depicted in FIG. 22 may also be interchangeable with other elements of FIGS. 1-21 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises an augmented reality management logic that is configured to:
receive an image and position data;
identify one or more objects visible in the image based on the position data;
obtain status data corresponding to the one or more objects; and
generate, based on the status data, overlay data associated with the image.

2. The device of claim 1, wherein the augmented reality management logic is further configured to transmit the overlay data to an augmented reality display.

3. The device of claim 1, wherein the overlay data corresponds to an augmented overlay configured to be superimposed on the image.

4. The device of claim 1, wherein the overlay data is configured to facilitate a generation of an augmented overlay to be superimposed on the image.

5. The device of claim 1, wherein identifying the one or more objects visible in the image comprises:
accessing an object identification database;
transmitting an identification request to indicate the device position data to the object identification database; and
receiving identification data from the object identification database in response to the identification request, wherein the one or more objects are identified based on the identification data.

6. The device of claim 1, wherein the augmented reality management logic is further configured to:
receive periodic status data of a plurality of objects; and
store the periodic status data of the plurality of objects.

7. The device of claim 6, wherein obtaining the status data comprises retrieving, from the stored periodic status data, the status data corresponding to the one or more objects.

8. The device of claim 1, wherein obtaining the status data comprises:
identifying at least one controller associated with the one or more objects;
transmitting a status request to the at least one controller; and
receiving the status data corresponding to the one or more objects from the at least one controller in response to the status request.

9. The device of claim 1, wherein the status data comprises power consumption data or version data of at least one of the one or more objects.

10. The device of claim 1, wherein the status data comprises communication port statistics data or client statistics data of at least one of the one or more objects.

11. The device of claim 1, wherein the status data comprises operational status data of at least one of the one or more objects.

12. The device of claim 11, wherein the operational status data comprises at least one of: a link status, a speed status, a fault status, or a data transfer status of at least one of the one or more objects.

13. The device of claim 1, wherein the augmented reality management logic is further configured to:
generate at least one control signal corresponding to the one or more objects based on the status data; and
transmit the at least one control signal to the one or more objects.

14. A device, comprising:
a processor;
a network interface controller configured to provide access to a network; and
a memory communicatively coupled to the processor, wherein the memory comprises an augmented reality management logic that is configured to:
receive an image and position data;
identify one or more objects visible in the image based on the position data;
obtain status data corresponding to the one or more objects;
translate the status data into one or more visual indicators; and
generate, based on the one or more visual indicators, overlay data associated with the image.

15. The device of claim 14, wherein the overlay data corresponds to an augmented overlay configured to be superimposed on the image.

16. The device of claim 15, wherein the augmented overlay comprises the one or more visual indicators.

17. The device of claim 16, wherein at least one visual indicator of the one or more visual indicators is a graphical element.

18. The device of claim 17, wherein the graphical element is configured to be at least partially superimposed on at least one of the one or more objects visible in the image.

19. The device of claim 14, wherein the augmented reality management logic is further configured to:
access a mapping database; and
identify the one or more visual indicators corresponding to the status data in the mapping database, wherein the status data is translated in response to identification of the one or more visual indicators in the mapping database.

20. A method comprising:
receiving an image and position data;
identifying one or more objects visible in the image based on the position data;
obtaining status data corresponding to the one or more objects; and
generating, based on the status data, overlay data associated with the image.
